(19) United States
(12) Patent Application Publication
(10) Pub. No.: US 2026/0273989 A1
(43) Pub. Date: Sep. 17, 2026

(54) APPARATUSES AND PROCESSES FOR PRODUCING OPTICAL EFFECTS LAYERS

(71) Applicant: SICPA HOLDING SA, Prilly (CH)

(72) Inventors: Neda NIKSERESHT GHANEPOUR, Lausanne (CH); Andrea CALLEGARI, Ecublens (CH)

(21) Appl. No.: 19/471,612

(22) PCT Filed: Mar. 27, 2024
(86) PCT No.: PCT/EP2024/058266

§ 371 Date: Oct. 1, 2025

(30) Foreign Application Priority Data
Apr. 3, 2023 (EP) 23166324.6

(51) Int. Cl. B42D 25/40; B42D 25/369

(52) U.S. Cl. CPC B42D 25/40; B42D 25/369

(57) ABSTRACT

The invention relates to the field of the protection of security documents such as for example banknotes and identity documents against counterfeit and illegal reproduction. In particular, the present invention provides apparatuses and processes for producing optical effect layers (OELs) comprising magnetically oriented, said optical effect layers (OELs) exhibiting not only a dynamic movement but also an eye-catching relief and/or 3D effect upon tilting and may be as anti-counterfeit means on security documents or security articles or for decorative purposes.

### FIELD OF THE INVENTION

The present invention relates to the field of apparatuses and processes for producing optical effect layers (OELs) and the use of said OELs as anti-counterfeit means on security documents or security articles as well as decorative purposes.

### BACKGROUND OF THE INVENTION

It is known in the art to use inks, compositions, coatings or layers containing oriented magnetic or magnetizable pigment particles, particularly also optically variable magnetic or magnetizable pigment particles, for the production of security elements, e.g. in the field of security documents. Coatings or layers comprising oriented magnetic or magnetizable pigment particles are disclosed for example in U.S. Pat. Nos. 2,570,856; 3,676,273; 3,791,864; 5,630,877; and 5,364,689. Coatings or layers comprising oriented magnetic color-shifting pigment particles, resulting in particularly appealing optical effects, useful for the protection of security documents, have been disclosed in WO 2002/090002 A2 and WO 2005/002866 A1.

Security features, e.g. for security documents, can generally be classified into “covert” security features on the one hand, and “overt” security features on the other hand. The protection provided by covert security features relies on the principle that such features are difficult to detect, typically requiring specialized equipment and knowledge for detection, whereas “overt” security features rely on the concept of being easily detectable with the unaided human senses, e.g. such features may be visible and/or detectable via the tactile sense while still being difficult to produce and/or to copy. However, the effectiveness of overt security features depends to a great extent on their easy recognition as a security feature.

Magnetic or magnetizable pigment particles in printing inks or coatings allow for the production of magnetically induced images, designs and/or patterns through the application of a correspondingly structured magnetic field, inducing a local orientation of the magnetic or magnetizable pigment particles in the not yet hardened (i.e. wet) coating, followed by the hardening of the coating. The result is a fixed and stable magnetically induced image, design or pattern (also known in the art as optical effect layer (OEL)). Materials and technologies for the orientation of magnetic or magnetizable pigment particles in coating compositions have been disclosed for example in U.S. Pat. Nos. 2,418,479; 2,570,856; 3,791,864; DE 2006848-A; U.S. Pat. Nos. 3,676,273; 5,364,689; 6,103,361; EP 0 406 667 B1; US 2002/0160194; US 2004/0009309; EP 0 710 508 A1; WO 2002/09002 A2; WO 2003/000801 A2; WO 2005/002866 A1; and WO 2006/061301 A1. In such a way, magnetically induced patterns which are highly resistant to counterfeit can be produced. The security element in question can only be produced by having access to both, the magnetic or magnetizable pigment particles or the corresponding ink, and the particular technology employed to print said ink and to orient said pigment in the printed ink.

Methods and devices have been developed to produce dynamic magnetically induced images on substrates, said images exhibiting a dynamic appearance upon tilting said substrates. Typical examples of said images include for example one or more moving bright reflective bars, or one or more moving loop-shaped bodies and one or more varying shape loop-shaped bodies such as described in US 2005/0106367 A1; WO 2020/193009 A1; WO 2020/160993 A1; WO 2013/167425 A1; WO 2021/083809 A1; WO 2021/083808 A1; WO 2014/108404 A2; WO 2014/108303 A2; WO 2018/054819 A1; WO 2019/215148 A1; WO 2020/025218 A1; WO WO2020/025482 A1; WO 2017/064052 A1; WO 2017/080698A1; WO 2017/148789 A1; and WO 2020/193009 A1,

The methods and devices described hereabove use magnetic assemblies to mono-axially orient magnetic pigment particles. Mono-axial orientation of magnetic pigment particles result in neighboring particles having their main (second longest) axis parallel to each other and to the magnetic field, while their minor axis in the plane of the pigment particles is not, or much less constrained by the applied magnetic field. Accordingly, a sole mono-axial orientation of magnetic pigment particles results in optical effect layers that may suffer from a low reflectivity and brightness as light is reflected in a wide range of directions, especially in directions that are substantially perpendicular to the magnetic field lines.

WO 2015/086257 A1 discloses an improved method for producing an optical effect layer (OEL) on a substrate, said process comprising two magnetic orientation steps, said steps consisting of i) exposing a coating composition comprising platelet-shaped magnetic or magnetisable pigment particles to a dynamic, i.e. direction changing, magnetic field of a first magnetic-field-generating device so as to bi-axially orient at least a part of the platelet-shaped magnetic or magnetisable pigment particles and ii) exposing the coating composition to a static magnetic field of a second magnetic-field-generating device, thereby mono-axially re-orienting at least a part of the platelet-shaped magnetic or magnetisable pigment particles according to a design transferred by said second magnetic-field-generating device.

Methods and devices have been developed to produce magnetically induced images on substrates exhibiting static indicia. EP 1 641 624 B1; EP 1 937 415 B1; and EP 2 155 498 B1 disclose devices and method for magnetically transferring indicia into a not yet hardened (i.e. wet) coating composition comprising magnetic or magnetizable pigment particles so as to form optical effect layers (OELs). The disclosed methods advantageously allow the production of security documents and articles having a customer-specific magnetic design.

Improved methods have been developed to produce optical effect layers (OELs) exhibiting eye-catching indicia having a 3D appearance and are disclosed in WO 2018/019594 A1 and WO 2018/033512 A1.

However, the methods of the prior art fail to provide eye-catching magnetically induced images combining a dynamic appearance and indicia in easy way to be implement and to work at a high production speed. Furthermore, magnetically induced images simultaneously exhibiting more than one optical effects according to the prior art require not only at least two sequential magnetic orientation steps but also the use of special curing apparatus such as photomask, laser or addressable LED and as disclosed in EP 3 170 566 B1; EP 3 459 758 A1; EP 2 542 421 B1; and WO 2020/148076 A1.

Therefore, a need remains for improved apparatuses and processes for producing eye-catching optical effect layers (OELs), wherein said processes should be reliable, easy to implement and able to work at a high production speed while allowing the production of OELs exhibiting not only an eye-catching relief and/or 3D indicia effect but also a dynamic movement.

### SUMMARY OF THE INVENTION

Accordingly, it is an object of the present invention to overcome the deficiencies of the prior art as discussed above. This is achieved by the provision of an apparatus (x00) for producing an optical effect layer (OEL) comprising magnetically oriented platelet-shaped magnetic or magnetizable pigment particles on a substrate (x50), said optical effect layer (OEL) exhibiting a dynamic movement upon tilting the substrate (x50) and one or more indicia, said apparatus (x00) being configured for receiving the substrate (x50) in an orientation substantially parallel to a first plane (P) and above the first plane (P) and being suitable to be used in combination with a second magnetic-field-generating device (x70) allowing at least a part of the particles to be to bi-axially oriented and comprising:
a) a soft magnetic plate (x10) carrying one or more indicia in the form of one or more indentations (x11) and/or one or more voids (x12) and/or one or more protrusions (x13), said soft magnetic plate (x10) having a top plate surface,
b) a magnetic-field-generating device (x20) comprising at least one dipole magnet (x20-a) and having a top device surface, wherein the soft magnetic plate (x10) is placed on top of the first magnetic-field-generating device (x20), and wherein the top plate surface is smaller than the top device surface.

Also described herein are uses of the apparatuses (x00) for magnetically orienting platelet-shaped magnetic or magnetizable pigment particles in a coating layer (x40) and producing the optical effect layer (OEL) described herein on the substrate described herein.

Also described herein are methods for producing the optical effect layers (OELs) described herein, said methods comprising the steps of:
a) applying onto the substrate (x50) surface a coating composition comprising i) platelet-shaped magnetic or magnetizable pigment particles and ii) a binder material so as to form a coating layer (x40) on said substrate (x50), said coating composition being in a first state,
b) forming an assembly (x100) comprising the substrate (x50) carrying the coating layer (x40) and the apparatus (x00) described herein,
c) moving the assembly (x100) comprising the substrate (x50) carrying the coating layer (x40) and the apparatus (x00) described herein obtained under step b) through an inhomogeneous magnetic field of a static second magnetic-field-generating device (x70) so as to bi-axially orient at least a part of the platelet-shaped magnetic or magnetizable pigment particles, and
d) hardening the coating composition to a second state so as to fix the platelet-shaped magnetic or magnetizable pigment particles in their adopted positions and orientations.

In one embodiment, the substrate (x50) of the assembly (x100) is arranged above the soft magnetic plate (x10), the soft magnetic plate (x10) facing the substrate (x50) and the coating layer (x40) being the topmost layer of the assembly (x100) and preferably being exposed to the environment, i.e. is not covered by any other layer or material.

Also described herein are optical effect layers (OELs) produced by the process described herein and security documents as well as decorative elements and objects comprising one or more optical OELs described herein.

Also described herein are uses of the apparatuses (x00) described herein together with the static second magnetic-field-generating devices (x70) described herein for magnetically orienting the platelet-shaped magnetic or magnetizable pigment particles in the coating layer (x40) described herein and manufacturing the optical effect layer (OEL) described herein.

Also described herein are methods of manufacturing a security document or a decorative element or object, comprising a) providing a security document or a decorative element or object, and b) providing an optical effect layer such as those described herein, in particular such as those obtained by the process described herein, so that it is comprised by the security document or decorative element or object.

The present invention provides apparatuses advantageously allowing the manufacture of eye-catching optical effect layers (OELs), said OELs comprising at least a first area exhibiting a 3D effect in the form of one or more indicia and at least a second area exhibiting a dynamic movement upon tilting, wherein at least one of said first area and at least one of said second area are adjacent as described herein.

The present invention also provides a reliable and easy to implement process to magnetically orient platelet-shaped magnetic or magnetizable pigment in a coating layer made of a coating composition in a first state, i.e. not yet hardened (i.e. wet) state, wherein the platelet-shaped magnetic or magnetizable pigment particles are free to move and rotate within the layer so as to form an optical effect layer (OEL) combining a dynamic movement with an eye-catching relief and/or 3D effect after having hardened said coating layer to a second state wherein orientation and position of the platelet-shaped magnetic or magnetizable pigment particles are fixed/frozen.

The magnetic orientation of the platelet-shaped magnetic or magnetizable pigment particles is carried out by forming the assembly comprising the substrate (x50) carrying the coating layer (x40), the apparatus comprising the soft magnetic plate carrying the one or more indicia in the form of one or more indentations and/or one or more voids and/or one or more protrusions and the magnetic-field-generating device comprising the at least one dipole magnet described herein and moving said assembly through the inhomogeneous magnetic field of a static second magnetic-field-generating device. The process described herein advantageously allow the production of optical effect layers comprising at least a first area exhibiting a 3D effect in the form of one or more indicia and at least a second area exhibiting a dynamic movement upon tilting, wherein at least one of said first area and at least one of said second area are adjacent as described herein, using a single composition comprising platelet-shaped magnetic or magnetizable pigment particles, in a single magnetic orientation step without requiring a selective hardening step. Accordingly, the process provided by the present invention is mechanically robust, easy to implement with an industrial high-speed printing equipment, without resorting to cumbersome, tedious and expensive modifications of said equipment.

### BRIEF DESCRIPTION OF DRAWINGS

The figures provided therein schematically illustrates the present invention and are not on scale. The optical effect layers (OEL) described herein and their production are now described in more detail with reference to the drawings and to particular embodiments, wherein

FIG. 1A schematically illustrates an example of an assembly (1100) for producing an optical effect layer (OEL) on a substrate (150) according to the present invention, wherein the assembly (1100) concomitantly moves (see the arrow) through an inhomogeneous magnetic field of a static second magnetic-field-generating device (170), said assembly (1100) comprising a) the substrate (150), b) a coating layer (140) comprising platelet-shaped magnetic or magnetizable pigment particles and c) an apparatus (100) according to the present invention and comprising a first magnetic-field-generating device (120), a soft magnetic plate (110) carrying indicia in the form of indentations/voids/protrusions (111, 112, 113) and a non-magnetic holder case (160). The so-obtained magnetic orientation of the platelet-shaped magnetic or magnetizable pigment particles is fixed/frozen by at least partially curing with a curing unit (180).

FIG. 1B schematically illustrate a cross-section of FIG. 1A, wherein the assembly (1100) moves (see the arrow) in the vicinity of the second magnetic-field-generating device (170). As shown in FIG. 1B, the first magnetic-field-generating device (120) is placed at a distance d-a from the soft magnetic plate (110) by means of the non-magnetic holder case (160).

FIG. 1C1 (top view) and FIG. 1C2 (cross-section) schematically illustrate a non-magnetic holder case (160) comprising a recess (190-a) for receiving the soft magnetic plate and an area (190-b) for receiving the first magnetic-field-generating device.

FIG. 2 schematically illustrates a top view of a suitable second magnetic-field-generating device (270) comprising a first set (S1) comprising a first bar dipole magnet (271-a) and two second bar dipole magnets (272-a and 272-d), a second set (S2) comprising a first bar dipole magnet (271-b) and two second bar dipole magnets (272-b and 272-e), a third set (S3) comprising a first bar dipole magnet (271-c) and two second bar dipole magnets (272-c and 272-f), a first pair (P1) of third bar dipole magnets (273-a and 273-b) and a second pair (P2) of third bar dipole magnets (273-c and 273-d).

FIGS. 3A1-A3 schematically illustrate top views of suitable soft magnetic plates (310) comprising indentations (311) (see FIG. 3A1), voids (312) (see FIG. 3A2) and protrusions (313) (see FIG. 3A3).

FIGS. 3B-F schematically illustrate cross-section of suitable soft magnetic plates (310) comprising indentations (311) (see FIG. 3B consisting of a cross-section of FIG. 3A1), voids (312) (see FIG. 3C consisting of a cross-section of FIG. 3A2), voids (312) with magnets (314) (see FIG. 3D), protrusions (313) (see FIG. 3E consisting of a cross-section of FIG. 3A3) and a combination of one or more indentations (311) with one or more voids (312) and one or more protrusions (313) (see FIG. 3F), wherein said one or more indentations (311) have a width W and a depth D, the one or more voids (312) have a width W and the one or more protrusions (313) have a width W and a height H.

FIGS. 4A-1, 4A-2 and 4B-4P schematically illustrate top views of suitable soft magnetic plates (410) placed on top of a non-magnetic holder case (460) of apparatuses (not shown) according to the present invention, wherein said soft magnetic plates (410) comprise one or more indentations (411) and/or one or more voids (412) and/or one or more protrusions (413) and optionally a magnetic plate (430) with engravings (431), wherein said plates (410) have various shapes and locations on top of the apparatuses.

FIGS. 5A1, 5A2, 5B1, 5B2, 5C-5F, 5G-1 and 5G-2 schematically illustrate different suitable first magnetic-field-generating devices (520).

FIGS. 6 A-P show photographic images optical effect layers (OELs) obtained by using the method shown in FIG. 1 with the apparatuses (x00) according to the invention as viewed under different viewing angles.

FIG. 7 shows a device employing the apparatuses (700).

### DETAILED DESCRIPTION

### Definitions

The following definitions are to be used to interpret the meaning of the terms discussed in the description and recited in the claims.

As used herein, the indefinite article “a” indicates one as well as more than one and does not necessarily limit its referent noun to the singular.

As used herein, the term “at least” is meant to define one or more than one, for example one or two or three.

As used herein, the term “about” means that the amount or value in question may be the specific value designated or some other value in its neighborhood. Generally, the term “about” denoting a certain value is intended to denote a range within ±5% of the value. As one example, the phrase “about 100” denotes a range of 100 5, i.e. the range from 95 to 105. Generally, when the term “about” is used, it can be expected that similar results or effects according to the invention can be obtained within a range of ±5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

The term “comprising” as used herein is intended to be non-exclusive and open-ended. Thus, for instance a coating composition comprising a compound A may include other compounds besides A.

However, the term “comprising” also covers, as a particular embodiment thereof, the more restrictive meanings of “consisting essentially of” and “consisting of”, so that for instance “a fountain solution comprising A, B and optionally C” may also (essentially) consist of A and B, or (essentially) consist of A, B and C.

The term “optical effect layer (OEL)” as used herein denotes a coating or layer that comprises oriented platelet-shaped magnetic or magnetizable pigment particles and a binder, wherein said platelet-shaped magnetic or magnetizable pigment particles are oriented by a magnetic field and wherein the oriented platelet-shaped magnetic or magnetizable pigment particles are fixed/frozen in their orientation and position (i.e. after hardening/curing) so as to form a magnetically induced image.

The term “coating composition” refers to any composition which is capable of forming an optical effect layer (EOL) on a solid substrate and which can be applied preferably but not exclusively by a printing method. The coating composition comprises the platelet-shaped magnetic or magnetizable pigment particles described herein and the binder described herein.

As used herein, the term “wet” refers to a coating layer which is not yet cured, for example a coating in which the platelet-shaped magnetic or magnetizable pigment particles are still able to change their positions and orientations under the influence of external forces acting upon them.

As used herein, the term “indicia” shall mean discontinuous layers such as patterns, including without limitation symbols, alphanumeric symbols, motifs, letters, words, numbers, logos and drawings.

The term “hardening” is used to denote a process wherein the viscosity of a coating composition in a first physical state which is not yet hardened (i.e. wet) is increased so as to convert it into a second physical state, i.e. a hardened or solid state, where the platelet-shaped magnetic or magnetizable pigment particles are fixed/frozen in their current positions and orientations and can no longer move nor rotate.

The term “security document” refers to a document which is usually protected against counterfeit or fraud by at least one security feature. Examples of security documents include without limitation value documents and value commercial goods.

The term “security feature” is used to denote an image, pattern or graphic element that can be used for authentication purposes.

Where the present description refers to “preferred” embodiments/features, combinations of these “preferred” embodiments/features shall also be deemed as disclosed as long as this combination of “preferred” embodiments/features is technically meaningful.

The present invention provides apparatuses (x00) for making optical effect layers (OELs) being suitable as security features against counterfeit or fraud and comprising magnetically oriented platelet-shaped magnetic or magnetizable pigment particles on substrates (x50), wherein said optical effect layers (OELs) exhibiting a 3D effect in the form of one or more indicia and a dynamic movement upon tilting and provides processes for producing said OELs made from coating compositions comprising platelet-shaped magnetic or magnetizable pigment particles through the magnetic orientation of said pigment particles by independently moving the assemblies (x100) comprising the substrates (x50) carrying the coatings layer (x40) comprising the pigment particles and the apparatus (x00) described herein through the inhomogeneous magnetic field of the static second magnetic assemblies (x70) such that the magnetic field in the coating layers (x40) changes at least in direction with time so as to bi-axially orient at least a part of the platelet-shaped magnetic or magnetizable pigment particles. The optical effect layers (OELs) described herein consists of at least a motif comprising at least a first area exhibiting a 3D effect in the form of one or more indicia and at least a second area exhibiting a dynamic movement upon tilting, wherein at least one of said first area and at least one of said second area are adjacent. By “adjacent”, it means that the first and second areas are contiguous (i.e. they share at least one region together and have a common border). The first and second areas of the motif are adjacent, preferably juxtaposed or interlaced. The first and second areas may be continuous or discontinuous.

The apparatuses (x00) and processes described herein allow the preparation of the optical effect layers (OELs) described herein, wherein said OELs comprise a motif made of at least two areas made of a single applied and cured layer and comprising magnetically oriented non-spherical magnetic or magnetizable particles

The process according to the present invention comprises the steps of:
a) applying on the substrate surface (x50) the coating composition comprising i) the platelet-shaped magnetic or magnetizable pigment particles described herein and ii) the binder material described herein so as to form the coating layer (x40) on said substrate, said coating composition being in a first state, b) forming the assembly (x100) comprising the substrate (x50) carrying the coating layer (x40) and the apparatus (x00) described herein, wherein the substrate (x50) carrying the coating layer (x40) is arranged above the assembly (x100), and wherein the coating layer (x40) preferably represents the topmost layer of the assembly (x100) and is preferably exposed to the environment,
c) moving the assembly (x100) comprising the substrate (x50) carrying the coating layer (x40) and the apparatus (x00) described herein obtained under step b) through the inhomogeneous magnetic field of the static second magnetic-field-generating device (x70) described herein so as to bi-axially orient at least a part of the platelet-shaped magnetic or magnetizable pigment particles, and
d) hardening the coating composition to a second state so as to fix the platelet-shaped magnetic or magnetizable pigment particles in their adopted positions and orientations.

The substrate (x50) carrying the coating layer (x40) is preferably arranged above the soft magnetic plate (x10) of the assembly (x100). By specifying that “the substrate (x50) carrying the coating layer (x40) is arranged above the soft magnetic plate (x10)”, a preferred case is encompassed where the soft magnetic plate (x10) and the substrate (x50) are arranged so that the substrate (x50) carrying the coating layer (x40) is arranged vertically directly above the soft magnetic plate, (x10) i.e. the direction of their arrangement relative to each other being in essence vertical.

The process described herein comprises a step a) of applying onto the substrate (x50) surface described herein the coating composition comprising platelet-shaped magnetic or magnetizable pigment particles described herein so as to form a coating layer (x40), said coating composition being in a first physical state which allows its application as a layer and which is in a not yet hardened (i.e. wet) state wherein the platelet-shaped magnetic or magnetizable pigment particles can move and rotate within the binder material. Since the coating composition described herein is to be provided on the substrate (x50), it is necessary that the coating composition comprising at least the binder material described herein and the platelet-shaped magnetic or magnetizable pigment particles is in a form that allows its processing on the desired printing or coating equipment. Preferably, said step a) is carried out by a printing process, preferably selected from the group consisting of screen printing, rotogravure printing, flexography printing and intaglio printing (also referred in the art as engraved copper plate printing and engraved steel die printing), more preferably selected from the group consisting of screen printing, rotogravure printing and flexography printing.

Screen printing (also referred in the art as silkscreen printing) is a stencil process wherein an ink is transferred to a surface through a stencil supported by a fine fabric mesh of silk, mono- or multi-filaments made of synthetic fibers such as for example polyamides or polyesters or metal threads stretched tightly on a frame made for example of wood or a metal (e.g. aluminum or stainless steel).

Alternatively, the screen-printing mesh may be a chemically etched, a laser-etched, or a galvanically formed porous metal foil, e.g. a stainless steel foil. The pores of the mesh are blocked in the non-image areas and left open in the image area, the image carrier being called the screen. Screen printing might be of the flat-bed or rotary type. Screen printing is further described for example in The Printing ink manual, R. H. Leach and R. J. Pierce, Springer Edition, 5^{th} Edition, pages 58-62 and in Printing Technology, J. M. Adams and P. A. Dolin, Delmar Thomson Learning, 5^{th} Edition, pages 293-328.

Rotogravure (also referred in the art as gravure) is a printing process wherein the image elements are engraved into the surface of a cylinder. The non-image areas are at a constant original level. Prior to printing, the entire printing plate (non-printing and printing elements) is inked and flooded with ink. Ink is removed from the non-image by a wiper or a blade before printing, so that ink remains only in the cells. The image is transferred from the cells to the substrate by a pressure typically in the range of 2 to 4 bars and by the adhesive forces between the substrate and the ink. The term rotogravure does not encompass intaglio printing processes (also referred in the art as engraved steel die or copper plate printing processes) which rely for example on a different type of ink. More details are provided in “Handbook of print media”, Helmut Kipphan, Springer Edition, page 48 and in The Printing ink manual, R. H. Leach and R. J. Pierce, Springer Edition, 5^{th} Edition, pages 42-51.

Flexography preferably uses a unit with a doctor blade, preferably a chambered doctor blade, an anilox roller and plate cylinder. The anilox roller advantageously has small cells whose volume and/or density determines the ink application rate. The doctor blade lies against the anilox roller, and scraps off surplus ink at the same time. The anilox roller transfers the ink to the plate cylinder which finally transfers the ink to the substrate. Specific design might be achieved using a designed photopolymer plate. Plate cylinders can be made from polymeric or elastomeric materials. Polymers are mainly used as photopolymer in plates and sometimes as a seamless coating on a sleeve. Photopolymer plates are made from light-sensitive polymers that are hardened by ultraviolet (UV) light. Photopolymer plates are cut to the required size and placed in an UV light exposure unit. One side of the plate is completely exposed to UV light to harden or cure the base of the plate. The plate is then turned over, a negative of the job is mounted over the uncured side and the plate is further exposed to UV light. This hardens the plate in the image areas. The plate is then processed to remove the unhardened photopolymer from the nonimage areas, which lowers the plate surface in these nonimage areas. After processing, the plate is dried and given a post-exposure dose of UV light to cure the whole plate. Preparation of plate cylinders for flexography is described in Printing Technology, J. M. Adams and P.A. Dolin, Delmar Thomson Learning, 5^{th} Edition, pages 359-360 and in The Printing ink manual, R. H. Leach and R. J. Pierce, Springer Edition, 5^{th} Edition, pages 33-42.

The coating composition described herein as well as the coating layer (x40) described herein comprise platelet-shaped magnetic or magnetizable pigment particles. Preferably, the platelet-shaped magnetic or magnetizable pigment particles described herein are present in an amount from about 5 wt-% to about 40 wt-%, more preferably about 10 wt-% to about 30 wt-%, the weight percentages being based on the total weight of the coating composition.

In contrast to needle-shaped pigment particles which can be considered as quasi one-dimensional particles, platelet-shaped pigment particles are quasi two-dimensional particles due to the large aspect ratio of their dimensions. Platelet-shaped pigment particle can be considered as a two-dimensional structure wherein the dimensions X and Y are substantially larger than the dimension Z.

Platelet-shaped pigment particles are also referred in the art as oblate particles or flakes. Such pigment particles may be described with a main axis X corresponding to their longest dimension crossing the pigment particle and a second axis Y perpendicular to X and corresponding to the second longest dimension crossing the pigment particle. In other words, the XY plane roughly defines the plane formed by the first and second longest dimensions of the pigment particle, the Z dimension being ignored.

The platelet-shaped magnetic or magnetizable pigment particles described herein have, due to their non-spherical shape, non-isotropic reflectivity with respect to incident electromagnetic radiation for which the hardened/cured binder material is at least partially transparent. As used herein, the term “non-isotropic reflectivity” denotes that the proportion of incident radiation from a first angle that is reflected by a particle into a certain (viewing) direction (a second angle) is a function of the orientation of the particles, i.e. that a change of the orientation of the particle with respect to the first angle can lead to a different magnitude of the reflection to the viewing direction.

In the OELs described herein, the platelet-shaped magnetic or magnetizable pigment particles described herein are dispersed in the coating composition comprising a hardened binder material that fixes the orientation of the platelet-shaped magnetic or magnetizable pigment particles. The binder material is at least in its hardened or solid state (also referred to as second state herein), at least partially transparent to electromagnetic radiation of a range of wavelengths comprised between 200 nm and 2500 nm, i.e. within the wavelength range which is typically referred to as the “optical spectrum” and which comprises infrared, visible and UV portions of the electromagnetic spectrum. Accordingly, the particles contained in the binder material in its hardened or solid state and their orientation-dependent reflectivity can be perceived through the binder material at some wavelengths within this range.

Preferably, the hardened binder material is at least partially transparent to electromagnetic radiation of a range of wavelengths comprised between 200 nm and 800 nm, more preferably comprised between 400 nm and 700 nm. Herein, the term “transparent” denotes that the transmission of electromagnetic radiation through a layer of 20 μm of the hardened binder material as present in the OEL (not including the platelet-shaped magnetic or magnetizable pigment particles, but all other optional components of the OEL in case such components are present) is at least 50%, more preferably at least 60%, even more preferably at least 70%, at the wavelength(s) concerned. This can be determined for example by measuring the transmittance of a test piece of the hardened binder material (not including the platelet-shaped magnetic or magnetizable pigment particles) in accordance with well-established test methods, e.g. DIN 5036-3 (1979-11). If the OEL serves as a covert security feature, then typically technical means will be necessary to detect the (complete) optical effect generated by the OEL under respective illuminating conditions comprising the selected non-visible wavelength; said detection requiring that the wavelength of incident radiation is selected outside the visible range, e.g. in the near UV-range. In this case, it is preferable that the OEL comprises luminescent pigment particles that show luminescence in response to the selected wavelength outside the visible spectrum contained in the incident radiation.

The infrared, visible and UV portions of the electromagnetic spectrum approximately correspond to the wavelength ranges between 700-2500 nm, 400-700 nm, and 200-400 nm respectively.

Suitable examples of platelet-shaped magnetic or magnetizable pigment particles described herein include without limitation pigment particles comprising a magnetic metal selected from the group consisting of cobalt (Co), iron (Fe), and nickel (Ni); a magnetic alloy of iron, manganese, cobalt, nickel or a mixture of two or more thereof; a magnetic oxide of chromium, manganese, cobalt, iron, nickel or a mixture of two or more thereof; or a mixture of two or more thereof. The term “magnetic” in reference to the metals, alloys and oxides is directed to ferromagnetic or ferrimagnetic metals, alloys and oxides.

Magnetic oxides of chromium, manganese, cobalt, iron, nickel or a mixture of two or more thereof may be pure or mixed oxides. Examples of magnetic oxides include without limitation iron oxides such as hematite (Fe₂O₃), magnetite (Fe₃O₄), chromium dioxide (CrO₂), magnetic ferrites (MFe₂O₄), magnetic spinels (MR₂O₄), magnetic hexaferrites (MFe₁₂O₁₉), magnetic orthoferrites (RFeO₃), magnetic garnets M₃R₂(AO₄)₃, wherein M stands for two-valent metal, R stands for three-valent metal, and A stands for four-valent metal.

Examples of platelet-shaped magnetic or magnetizable pigment particles described herein include without limitation pigment particles comprising a magnetic layer M made from one or more of a magnetic metal such as cobalt (Co), iron (Fe), or nickel (Ni); and a magnetic alloy of iron, cobalt or nickel, wherein said magnetic or magnetizable pigment particles may be multilayered structures comprising one or more additional layers. Preferably, the one or more additional layers are layers A independently made from one or more selected from the group consisting of metal fluorides such as magnesium fluoride (MgF₂), silicon oxide (SiO), silicon dioxide (SiO₂), titanium oxide (TiO₂), and aluminum oxide (Al₂O₃), more preferably silicon dioxide (SiO₂); or layers B independently made from one or more selected from the group consisting of metals and metal alloys, preferably selected from the group consisting of reflective metals and reflective metal alloys, and more preferably selected from the group consisting of aluminum (AI), chromium (Cr), and nickel (Ni), and still more preferably aluminum (AI); or a combination of one or more layers A such as those described hereabove and one or more layers B such as those described hereabove. Typical examples of the platelet-shaped magnetic or magnetizable pigment particles being multilayered structures described hereabove include without limitation A/M multilayer structures, A/M/A multilayer structures, A/M/B multilayer structures, A/B/M/A multilayer structures, A/B/M/B multilayer structures, A/B/M/B/A/multilayer structures, B/M multilayer structures, B/M/B multilayer structures, B/A/M/A multilayer structures, B/A/M/B multilayer structures, B/A/M/B/A/multilayer structures, wherein the layers A, the magnetic layers M and the layers B are chosen from those described hereabove.

The coating composition described herein may comprise platelet-shaped optically variable magnetic or magnetizable pigment particles, and/or platelet-shaped magnetic or magnetizable pigment particles having no optically variable properties. Preferably, at least a part of the platelet-shaped magnetic or magnetizable pigment particles described herein is constituted by platelet-shaped optically variable magnetic or magnetizable pigment particles. In addition to the overt security provided by the color-shifting property of the optically variable magnetic or magnetizable pigment particles, which allows easily detecting, recognizing and/or discriminating an article or security document carrying an ink, coating composition, or coating layer comprising the optically variable magnetic or magnetizable pigment particles described herein from their possible counterfeits using the unaided human senses, the optical properties of the optically variable magnetic or magnetizable pigment particles may also be used as a machine readable tool for the recognition of the OEL. Thus, the optical properties of the optically variable magnetic or magnetizable pigment particles may simultaneously be used as a covert or semi-covert security feature in an authentication process wherein the optical (e.g. spectral) properties of the pigment particles are analyzed.

The use of platelet-shaped optically variable magnetic or magnetizable pigment particles in coating layers for producing an OEL enhances the significance of the OEL as a security feature in security document applications, because such materials are reserved to the security document printing industry and are not commercially available to the public.

As mentioned above, preferably at least a part of the platelet-shaped magnetic or magnetizable pigment particles is constituted by platelet-shaped optically variable magnetic or magnetizable pigment particles. These are more preferably selected from the group consisting of magnetic thin-film interference pigment particles, magnetic cholesteric liquid crystal pigment particles, interference coated pigment particles comprising a magnetic material and mixtures of two or more thereof.

Magnetic thin film interference pigment particles are known to those skilled in the art and are disclosed e.g. in U.S. Pat. No. 4,838,648; WO 2002/073250 A2; EP 0 686 675 B1; WO 2003/000801 A2; U.S. Pat. No. 6,838,166; WO 2007/131833 A1; EP 2 402 401 B1; WO 2019/103937 A1; WO 2020/006286 A1 and in the documents cited therein. Preferably, the magnetic thin film interference pigment particles comprise pigment particles having a five-layer Fabry-Perot multilayer structure and/or pigment particles having a six-layer Fabry-Perot multilayer structure and/or pigment particles having a seven-layer Fabry-Perot multilayer structure and/or pigment particles having a multilayer structure combining one or more multilayer Fabry-Perot structures.

Preferred five-layer Fabry-Perot multilayer structures consist of absorber/dielectric/reflector/dielectric/absorber multilayer structures wherein the reflector and/or the absorber is also a magnetic layer, preferably the reflector and/or the absorber is a magnetic layer comprising nickel, iron and/or cobalt, and/or a magnetic alloy comprising nickel, iron and/or cobalt and/or a magnetic oxide comprising nickel (Ni), iron (Fe) and/or cobalt (Co).

Preferred six-layer Fabry-Perot multilayer structures consist of absorber/dielectric/reflector/magnetic/dielectric/absorber multilayer structures.

Preferred seven-layer Fabry Perot multilayer structures consist of absorber/dielectric/reflector/magnetic/reflector/dielectric/absorber multilayer structures such as disclosed in U.S. Pat. No. 4,838,648.

Preferred pigment particles having a multilayer structure combining one or more Fabry-Perot structures are those described in WO 2019/103937 A1 and consist of combinations of at least two Fabry-Perot structures, said two Fabry-Perot structures independently comprising a reflector layer, a dielectric layer and an absorber layer, wherein the reflector and/or the absorber layer can each independently comprise one or more magnetic materials and/or wherein a magnetic layer is sandwich between the two structures. WO 2020/006/286 A1 and EP 3 587 500 A1 disclose further preferred pigment particles having a multilayer structure.

Preferably, the reflector layers described herein are independently made from one or more selected from the group consisting of metals and metal alloys, preferably selected from the group consisting of reflective metals and reflective metal alloys, more preferably selected from the group consisting of aluminum (Al), silver (Ag), copper (Cu), gold (Au), platinum (Pt), tin (Sn), titanium (Ti), palladium (Pd), rhodium (Rh), niobium (Nb), chromium (Cr), nickel (Ni), and alloys thereof, even more preferably selected from the group consisting of aluminum (Al), chromium (Cr), nickel (Ni) and alloys thereof, and still more preferably aluminum (Al). Preferably, the dielectric layers are independently made from one or more selected from the group consisting of metal fluorides such as magnesium fluoride (MgF₂), aluminum fluoride (AlF₃), cerium fluoride (CeF₃), lanthanum fluoride (LaF₃), sodium aluminum fluorides (e.g. Na₃AlF₆), neodymium fluoride (NdF₃), samarium fluoride (SmF₃), barium fluoride (BaF₂), calcium fluoride (CaF₂), lithium fluoride (LiF), and metal oxides such as silicon oxide (SiO), silicon dioxide (SiO₂), titanium oxide (TiO₂), aluminum oxide (Al₂O₃), more preferably selected from the group consisting of magnesium fluoride (MgF₂) and silicon dioxide (SiO₂) and still more preferably magnesium fluoride (MgF₂). Preferably, the absorber layers are independently made from one or more selected from the group consisting of aluminum (Al), silver (Ag), copper (Cu), palladium (Pd), platinum (Pt), titanium (Ti), vanadium (V), iron (Fe) tin (Sn), tungsten (W), molybdenum (Mo), rhodium (Rh), Niobium (Nb), chromium (Cr), nickel (Ni), metal oxides thereof, metal sulfides thereof, metal carbides thereof, and metal alloys thereof, more preferably selected from the group consisting of chromium (Cr), nickel (Ni), metal oxides thereof, and metal alloys thereof, and still more preferably selected from the group consisting of chromium (Cr), nickel (Ni), and metal alloys thereof. Preferably, the magnetic layer comprises nickel (Ni), iron (Fe) and/or cobalt (Co); and/or a magnetic alloy comprising nickel (Ni), iron (Fe) and/or cobalt (Co); and/or a magnetic oxide comprising nickel (Ni), iron (Fe) and/or cobalt (Co).

When magnetic thin film interference pigment particles comprising a seven-layer Fabry-Perot structure are preferred, it is particularly preferred that the magnetic thin film interference pigment particles comprise a seven-layer Fabry-Perot absorber/dielectric/reflector/magnetic/reflector/dielectric/absorber multilayer structure consisting of a Cr/MgF₂/Al/Ni/Al/MgF₂/Cr multilayer structure.

The magnetic thin film interference pigment particles described herein may be multilayer pigment particles being considered as safe for human health and the environment and being based for example on five-layer Fabry-Perot multilayer structures, six-layer Fabry-Perot multilayer structures, seven-layer Fabry-Perot multilayer structures and pigment particles having a multilayer structure combining one or more multilayer Fabry-Perot structures, wherein said pigment particles include one or more magnetic layers comprising a magnetic alloy having a substantially nickel-free composition including about 40 wt-% to about 90 wt-% iron, about 10 wt-% to about 50 wt-% chromium and about 0 wt-% to about 30 wt-% aluminum. Typical examples of multilayer pigment particles being considered as safe for human health and the environment can be found in EP 2 402 401 B1 whose content is hereby incorporated by reference in its entirety.

Suitable magnetic cholesteric liquid crystal pigment particles exhibiting optically variable characteristics include without limitation magnetic monolayered cholesteric liquid crystal pigment particles and magnetic multilayered cholesteric liquid crystal pigment particles. Such pigment particles are disclosed for example in WO 2006/063926 A1, U.S. Pat. Nos. 6,582,781 and 6,531,221. WO 2006/063926 A1 discloses monolayers and pigment particles obtained therefrom with high brilliance and color-shifting properties with additional particular properties such as magnetizability. The disclosed monolayers and pigment particles, which are obtained therefrom by comminuting said monolayers, include a three-dimensionally crosslinked cholesteric liquid crystal mixture and magnetic nanoparticles. U.S. Pat. Nos. 6,582,781 and 6,410,130 disclose platelet-shaped cholesteric multilayer pigment particles which comprise the sequence A¹/B/A², wherein A¹ and A² may be identical or different and each comprises at least one cholesteric layer, and B is an interlayer absorbing all or some of the light transmitted by the layers A¹ and A² and imparting magnetic properties to said interlayer. U.S. Pat. No. 6,531,221 discloses platelet-shaped cholesteric multilayer pigment particles which comprise the sequence A/B and optionally C, wherein A and C are absorbing layers comprising pigment particles imparting magnetic properties, and B is a cholesteric layer.

Suitable interference coated pigment particles comprising one or more magnetic materials include without limitation structures consisting of a substrate selected from the group consisting of a core coated with one or more layers, wherein at least one of the core or the one or more layers have magnetic properties. For example, suitable interference coated pigment particles comprise a core made of a magnetic material such as those described hereabove, said core being coated with one or more layers made of one or more metal oxides, or they have a structure consisting of a core made of synthetic or natural micas, layered silicates (e.g. talc, kaolin and sericite), glasses (e.g. borosilicates), silicon dioxides (SiO₂), aluminum oxides (Al₂O₃), titanium oxides (TiO₂), graphites and mixtures of two or more thereof. Furthermore, one or more additional layers such as coloring layers may be present.

The platelet-shaped magnetic or magnetizable pigment particles described herein may be surface treated so as to protect them against any deterioration that may occur in the coating composition and coating layer and/or to facilitate their incorporation in said coating composition and coating layer, typically corrosion inhibitor materials and/or wetting agents may be used.

Further, subsequently to the application of the coating composition described herein on the substrate (x50) surface described herein so as to form the coating layer (x40) (step a)) described herein, the assembly (x100) comprising the substrate (x50) carrying the coating layer (x40) and the apparatus (x00) described herein is formed (step b)), wherein the substrate (50) carrying the coating layer (x40) is arranged above the apparatus (x00), preferably wherein the apparatus (x00) faces the substrate (x50), the one or more indentations (x11) and/or one or more voids (x12) and/or one or more protrusions (x13) independently face the substrate (x50) and wherein the coating layer (x40) represents the topmost layer of the assembly (x100) and is exposed to the environment.

Subsequently to the formation of the assembly (x100) (step b)) described herein, the platelet-shaped magnetic or magnetizable pigment particles are oriented (step c)) by moving said assembly (x100) through the inhomogeneous magnetic field of the static second magnetic-field-generating device (x70) described herein so as to bi-axially orient at least a part of the platelet-shaped magnetic or magnetizable pigment particles.

By “inhomogeneous magnetic field”, it is meant that along the path of motion followed by individual platelet-shaped magnetic or magnetizable pigment particles of the coating layer (x40), the magnetic field lines change at least in direction within a plane which is fixed in the reference frame of the moving assembly. In this way, at least a part of the platelet-shaped magnetic or magnetizable pigment particles of the coating layer tend to align within said plane, resulting in a bi-axial orientation of said platelet-shaped magnetic or magnetizable particles, i.e. an orientation in which the two largest principal axes of said platelet-shaped pigment particles are constrained. During this bi-axial orientation, the apparatus affects the direction and/or intensity of the magnetic field generated by the static second magnetic-field-generating device, thus affecting the orientation of the platelet-shaped magnetic or magnetizable pigment particles so as to produce the desired eye-catching effect. Once the desired effect is created in the not yet hardened (i.e. wet) coating layer, the coating composition is partly or completely hardened so as to permanently fix/freeze the relative position and orientation of the platelet-shaped magnetic or magnetizable pigment particles in the OEL.

In one embodiment, the assembly (x100) described herein moves in the vicinity and above the second magnetic-field-generating device (x70) described herein, the substrate (x50) preferably facing said second magnetic-field-generating device (x70) described herein. In another embodiment, the assembly (x100) described herein moves in the vicinity and below the second magnetic-field-generating device (x70) described herein, the coating layer (x40) preferably facing said second magnetic-field-generating device (x70) described herein. In another embodiment, the assembly (x100) described herein moves in the vicinity between or beside magnets of the second magnetic-field-generating device (x70) described herein.

Subsequently to or partially simultaneously, preferably partially simultaneously, with the steps of orienting the platelet-shaped magnetic or magnetizable pigment particles by moving the assembly (x100) through the inhomogeneous magnetic field of the static second magnetic-field-generating device (x70) described herein (step c)), the orientation of the platelet-shaped magnetic or magnetizable pigment particles is fixed or frozen (step d)). The coating composition must thus noteworthy have a first state, i.e. a liquid or pasty state, wherein the coating composition is not yet hardened and wet or soft enough, so that the platelet-shaped magnetic or magnetizable pigment particles dispersed in the coating composition are freely movable, rotatable and orientable upon exposure to a magnetic field, and a second hardened (e.g. solid or solid-like) state, wherein the platelet-shaped magnetic or magnetizable pigment particles are fixed or frozen in their respective positions and orientations.

Such a first and second state is preferably provided by using a certain type of coating compositions. For example, the components of the coating composition other than the platelet-shaped magnetic or magnetizable pigment particles may take the form of an ink or coating composition such as those which are used in security applications, e.g. for banknote printing. The aforementioned first and second states can be provided by using a material that shows an increase in viscosity in reaction to a stimulus such as for example a temperature change or an exposure to an electromagnetic radiation.

That is, when the fluid binder material is hardened or solidified, said binder material converts into the second state, i.e. a hardened or solid state, where the platelet-shaped magnetic or magnetizable pigment particles are fixed in their current positions and orientations and can no longer move nor rotate within the binder material. As known to those skilled in the art, ingredients comprised in an ink or coating composition to be applied onto a surface such as a substrate and the physical properties of said ink or coating composition must fulfil the requirements of the process used to transfer the ink or coating composition to the substrate (x50) surface. Consequently, the binder material comprised in the coating composition described herein is typically chosen among those known in the art and depends on the coating or printing process used to apply the ink or coating composition and the chosen hardening process.

The hardening step described herein (step d)) can be of purely physical nature, e.g. in cases where the coating composition comprises a polymeric binder material and a solvent and is applied at high temperatures. Then, the platelet-shaped magnetic or magnetizable pigment particles are oriented at high temperature by the application of a magnetic field, and the solvent is evaporated, followed by cooling of the coating composition. Thereby the coating composition is hardened, and the orientation of the particles is fixed.

Alternatively and preferably, the hardening of the coating composition involves a chemical reaction, for instance by curing, which is not reversed by a simple temperature increase (e.g. up to 80° C.) that may occur during a typical use of a security document. The term “curing” or “curable” refers to processes including the chemical reaction, crosslinking or polymerization of at least one component in the applied coating composition in such a manner that it turns into a polymeric material having a greater molecular weight than the starting substances. Preferably, the curing causes the formation of a stable three-dimensional polymeric network. Such a curing is generally induced by applying an external stimulus to the coating composition (i) after its application on a substrate (step a)) and (ii) subsequently to, or partially simultaneously with the bi-axial orientation of at least part of the platelet-shaped magnetic or magnetizable pigment particles (step c)). Advantageously the hardening (step d)) of the coating composition described herein is carried out partially simultaneously with the orientation of at least a part of the platelet-shaped magnetic or magnetizable pigment particles (step c)). Therefore, preferably the coating composition is selected from the group consisting of radiation curable compositions, thermally drying compositions, oxidatively drying compositions, and combinations thereof. Particularly preferred are coating compositions selected from the group consisting of radiation curable compositions.

Radiation curing, in particular UV-Vis curing, advantageously leads to an instantaneous increase in viscosity of the coating composition after exposure to the irradiation, thus preventing any further movement of the pigment particles and in consequence any loss of information after the magnetic orientation step. Preferably, the hardening step (step d)) is carried out by irradiation with UV-visible light (i.e. UV-Vis light radiation curing) or by E-beam (i.e. E-beam radiation curing), more preferably by irradiation with UV-Vis light.

Therefore, suitable coating compositions for the present invention include radiation curable compositions that may be cured by UV-visible light radiation (hereafter referred as UV-Vis-curable) or by E-beam radiation (hereafter referred as EB). According to one particularly preferred embodiment of the present invention, the coating composition described herein is a UV-Vis-curable coating composition. UV-Vis curing advantageously allows very fast curing processes and hence drastically decreases the preparation time of the OEL described herein, documents and articles and documents comprising said OEL.

Preferably, the UV-Vis-curable coating composition comprises one or more compounds selected from the group consisting of radically curable compounds and cationically curable compounds. The UV-Vis-curable coating composition described herein may be a hybrid system and comprise a mixture of one or more cationically curable compounds and one or more radically curable compounds.

Cationically curable compounds are cured by cationic mechanisms typically including the activation by radiation of one or more photoinitiators which liberate cationic species, such as acids, which in turn initiate the curing so as to react and/or cross-link the monomers and/or oligomers to thereby harden the coating composition. Radically curable compounds are cured by free radical mechanisms typically including the activation by radiation of one or more photoinitiators, thereby generating radicals which in turn initiate the polymerization so as to harden the coating composition. Depending on the monomers, oligomers or prepolymers used to prepare the binder comprised in the UV-Vis-curable coating compositions described herein, different photoinitiators might be used. Suitable examples of free radical photoinitiators are known to those skilled in the art and include without limitation acetophenones, benzophenones, benzyldimethyl ketals, alpha-aminoketones, alpha-hydroxyketones, phosphine oxides and phosphine oxide derivatives, as well as mixtures of two or more thereof. Suitable examples of cationic photoinitiators are known to those skilled in the art and include without limitation onium salts such as organic iodonium salts (e.g. diaryl iodoinium salts), oxonium (e.g. triaryloxonium salts) and sulfonium salts (e.g. triarylsulphonium salts), as well as mixtures of two or more thereof. Other examples of useful photoinitiators can be found in standard textbooks. It may also be advantageous to include a sensitizer in conjunction with the one or more photoinitiators in order to achieve efficient curing. Typical examples of suitable photosensitizers include without limitation isopropyl-thioxanthone (ITX), 1-chloro-2-propoxy-thioxanthone (CPTX), 2-chloro-thioxanthone (CTX) and 2,4-diethyl-thioxanthone (DETX) and mixtures of two or more thereof. The one or more photoinitiators comprised in the UV-Vis-curable coating compositions are preferably present in a total amount from about 0.1 wt-% to about 20 wt-%, more preferably about 1 wt-% to about 15 wt-%, the weight percents being based on the total weight of the UV-Vis-curable coating compositions.

Alternatively, a polymeric thermoplastic binder material or a thermoset may be employed. Typical examples of thermoplastic resin or polymer include without limitation polyamides, polyesters, polyacetals, polyolefins, styrenic polymers, polycarbonates, polyarylates, polyimides, polyether ether ketones (PEEK), polyetherketeoneketones (PEKK), polyphenylene based resins (e.g. polyphenylenethers, polyphenylene oxides, polyphenylene sulfides), polysulphones and mixtures of two or more thereof.

The coating composition described herein may further comprise one or more additives including without limitation compounds and materials which are used for adjusting physical, rheological and chemical parameters of the composition such as the viscosity (e.g. solvents and surfactants), the consistency (e.g. anti-settling agents, fillers and plasticizers), the foaming properties (e.g. antifoaming agents), the lubricating properties (waxes), UV reactivity and stability (photosensitizers and photostabilizers) and adhesion properties, etc. Additives described herein may be present in the coating compositions described herein in amounts and in forms known in the art, including in the form of so-called nano-materials where at least one of the dimensions of the particles is in the range of 1 to 1000 nm.

The coating composition described herein may further comprise one or more marker substances or taggants and/or one or more machine readable materials selected from the group consisting of magnetic materials (different from the magnetic or magnetizable pigment particles described herein), luminescent materials, electrically conductive materials and infrared-absorbing materials. As used herein, the term “machine readable material” refers to a material which exhibits at least one distinctive property which is detectable by a device or a machine, and which can be comprised in a coating so as to confer a way to authenticate said coating or article comprising said coating by the use of a particular equipment for its detection and/or authentication.

The coating compositions described herein may be prepared by dispersing or mixing the magnetic or magnetizable pigment particles described herein and the one or more additives when present in the presence of the binder material described herein, thus forming liquid compositions. When present, the one or more photoinitiators may be added to the composition either during the dispersing or mixing step of all other ingredients or may be added at a later stage, i.e. after the formation of the liquid coating composition.

As described herein, the assembly (x100) comprises the substrate (x50) carrying the coating layer (x40) and the apparatus (x00) described herein, wherein the substrate (x50) carrying the coating layer (x40) is arranged above the apparatus (x00), and wherein the coating layer (x40) preferably represents the topmost layer of the assembly and is exposed to the environment.

The apparatus (x00) described herein is configured for receiving the substrate (x50) in an orientation substantially parallel to a first plane (P) and above the first plane (P) and is suitable to be used in combination with the static second magnetic-field-generating device (x70) described herein allowing at least a part of the particles to be to bi-axially oriented, wherein said apparatus (x00) comprises a) the soft magnetic plate (x10) carrying one or more indicia in the form of one or more indentations (x11) and/or one or more voids (x12) and/or one or more protrusions (x13) and having a top plate surface, and b) a first magnetic-field-generating device (x20) comprising at least one dipole magnet and having a top device surface, wherein the soft magnetic plate (x10) is placed on top of the first magnetic-field-generating device (x20) and wherein the top plate surface is smaller than the top device surface. Since the top plate surface is smaller than the top device surface, the top surface of the apparatus (x00) described herein comprises one or more regions being free from the soft magnetic plate (x10).

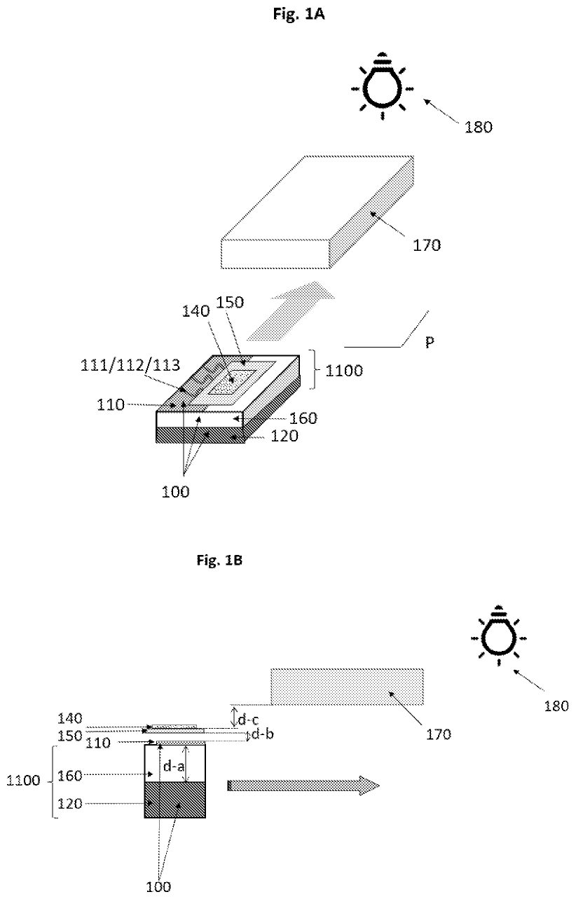

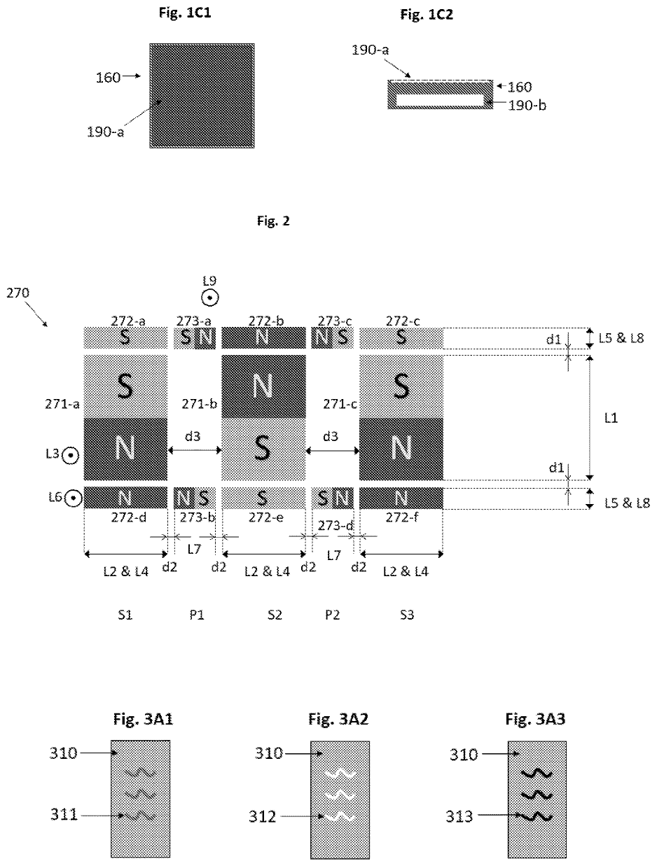

The distance d-a (shown in FIG. 1B) between the bottom surface of the soft magnetic plate (x10) and the top surface of the first magnetic-field-generating device (x20) and the distance d-b (shown in FIG. 1B) between the top surface of the soft magnetic plate (x10) and the bottom surface of the substrate (x50) is adjusted and selected to obtain the desired optical effect layers (OELs). It is particularly preferred to use a distance d-b close to zero or being zero.

According to one embodiment, the assembly (x100) comprises the substrate (x50) carrying the coating layer (x40) and the apparatus (x00) described herein, said apparatus (x00) comprising the soft magnetic plate (x10) carrying one or more indicia in the form of one or more indentations (x11) and/or one or more voids (x12) and/or one or more protrusions (x13) and the first magnetic-field-generating device (x20), wherein the substrate (x50) carrying the coating layer (x40) is arranged above the soft magnetic plate (x10) (i.e. wherein the coating layer (x40) preferably represents the topmost layer of the assembly (x100) and is preferably exposed to the environment) and the one or more indicia in the form of one or more indentations (x11) face the substrate (x50), the one or more indicia in the form of one or more voids (x12) face the substrate (x50) and the first magnetic-field-generating device (x20), and the one or more indicia in the form one or more protrusions (x13) face the substrate (x50), i.e. the side being opposite to the first magnetic-field-generating device (x20).

The soft magnetic plate (x10) described herein carries one or more indicia in the form of one or more indentations (x11) and/or one or more voids (x12) and/or one or more protrusions (x13). The expression “indentation” refers to a negative recess having a depth in a surface, the expression “void” refers to a hole or channel which goes through the soft magnetic plate (x10) and connects both sides thereof (i.e. the void has a depth of 100% in comparison with the thickness of the soft magnetic plate (x10)), and the expression “protrusion” refers to a positive relief extending out of the surface. The indentations (x11) and protrusions (x13) described herein may be produced by adding material to the surface or by taking off material from the surface of the soft magnetic plate (x10). The voids (x12) described herein may be produced by taking off material from the entire thickness of the soft magnetic plate (x10) or by adding material to the surface of a non-magnetic holder, when a non-magnetic holder is used.

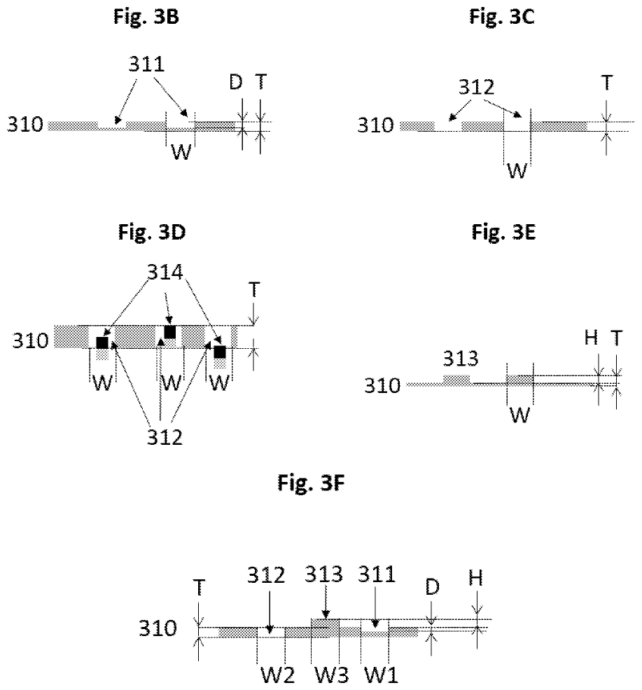

According to one embodiment, the soft magnetic metal plate (x10) described herein comprises one or more indentations (x11) having a width (W) and depth (D). FIGS. 3A1 and 3B schematically depict a top view (FIG. 3A1) and a cross section (FIG. 3B) of a soft magnetic plate (310) comprising one or more indicia in the form of one or more indentations (311), wherein said soft magnetic plate (310) has a thickness (T) and said one or more indentations (311) have a depth (D) and a width (W). As shown in FIG. 3B, the thickness (T) of the soft magnetic plate (310) comprising one or more indentations (311) refers to the thickness of the regions of the soft magnetic plate (310) lacking the one or more indentations (311) (i.e. the thickness of the non-indented regions of the soft magnetic plate (310)). For embodiments wherein the soft magnetic plate (x10) comprises the one or more indentations (x11) described herein, said one or more indentations (x11) preferably have the depth (D) described herein.

FIGS. 3A2 and 3C schematically depict a top view (FIG. 3A2) and a cross section (FIG. 3C) of a soft magnetic plate (310) comprising one or more indicia in the form of one or more voids (312), wherein said soft magnetic plate has a thickness (T) and said one or more voids (312) have a width (W). As shown in FIG. 3C, the thickness (T) of the soft magnetic plate (310) comprising one or more voids (312) refers to the thickness of the regions of the soft magnetic plate (310) lacking the one or more voids (312). As shown in FIG. 3D, the soft magnetic plate (310) comprising the one or more voids (312) may further comprise one or more bar dipole magnets (314) in said one or more voids (312).

According to another embodiment, the soft magnetic metal plate (x10) described herein comprises one or more protrusions (x13) having a width (W) and height (H). FIGS. 3A3 and 3E schematically depict a top view (FIG. 3A3) and a cross section (FIG. 3E) of a soft magnetic plate (310) comprising one or more indicia in the form of one or more protrusions (313), wherein said soft magnetic plate (310) has a thickness (T) and said one or more protrusions have a height (H) and a width (W). As shown in FIG. 3E, the thickness (T) of the soft magnetic plate (310) comprising one or more protrusions (313) refers to the thickness of the soft magnetic plate (310) from which the one or more protrusions (313) projects. This is, in this case, the thickness (T) is not the total thickness of the soft magnetic plate (310) but rather refers to the level from which the one or more protrusions (313) project. For embodiments wherein the soft magnetic plate (x10) comprises the one or more protrusions (x13) described herein, said one or more protrusions (x13) preferably have the height (H) described herein.

The soft magnetic plate (x10) comprising one or more voids (x12) may be attached to a non-magnetic holder gluing said plate to the non-magnetic holder or mechanical means may be used.

According to another embodiment, the soft magnetic metal plate (x10) described herein comprises one or more indentations (x11) and one or more voids (x12). According to another embodiment, the soft magnetic metal plate (x10) described herein comprises one or more indentations (x11) and one or more protrusions (x13). According to another embodiment, the soft magnetic metal plate (x10) described herein comprises one or more voids (x12) and one or more protrusions (x13).

According to another embodiment, the soft magnetic metal plate (x10) described herein comprises one or more indentations (x11), one or more voids (x12) and one or more protrusions (x13). For embodiments wherein a combination of indentations (x11), voids (x12), protrusions (x13) are used, the preferred depths (D) and preferred heights (H) are those described herein.

FIG. 3F schematically depict a cross section of a soft magnetic plate (310) comprising one or more indicia in the form of one or more indentations (311), one or more voids (312) and one or more protrusions (313), wherein said soft magnetic plate has a thickness (T), said one or more indentations (311) have a width (W1) and a depth (D), said one or more voids (312) have a width (W2) and said one or more protrusions (313) have a width (W3) and a height (H).

The apparatus (x00) described herein may further comprises one or more dipole magnets (x14) arranged in the one or more indentations (x11) and/or in the one or more voids (x12) of the soft magnetic plate (x10). Preferably, the top surface of the one or more dipole magnets (x14) provided in the one or more indentations (x11) and/or in the one or more voids (x12) of the soft magnetic plate (x10) is below or flush with the top surface of the soft magnetic plate (x10).

According to one embodiment, the soft magnetic plate (x10) described herein carries one or more indicia in the form of one or more indentations (x11) and/or one or more voids (x12) and/or one or more protrusions (x13), wherein one or more empty volumes defined by said one or more indentations (x11), (x12) and protrusions (x13), as the case may be, may be independently filled up with a non-magnetic material including a polymeric binder such as those described hereabove and optionally fillers for the purpose of providing the apparatus (x00) with a smooth top surface.

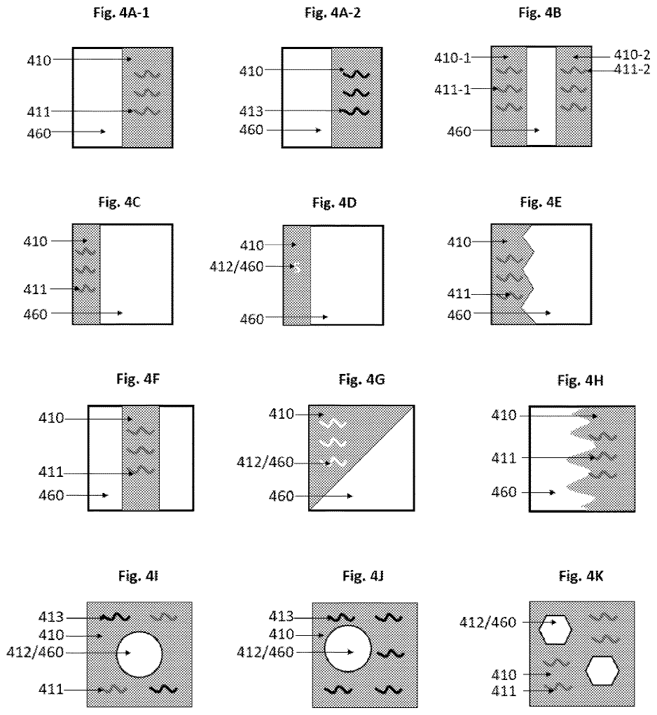

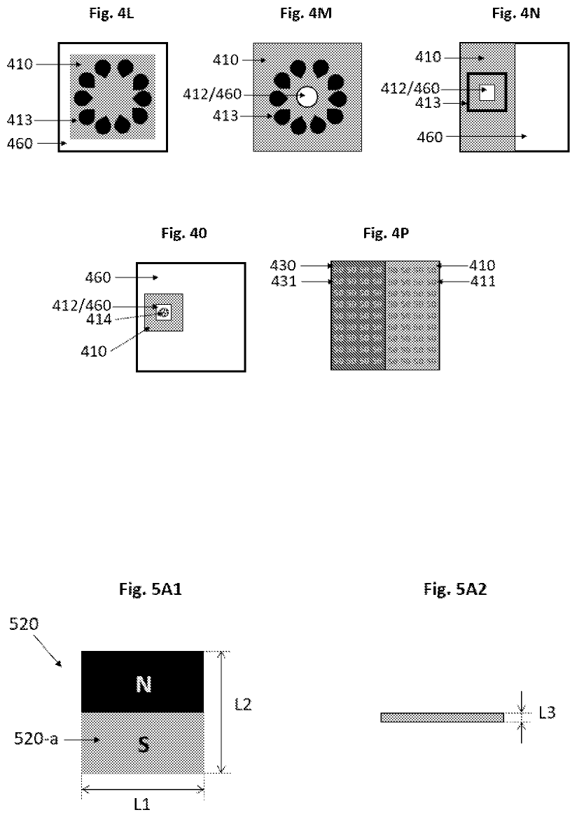

The soft magnetic plate (x10) described herein has a top plate surface being smaller than the top device surface of the magnetic-field-generating device (x20) of the apparatus (x00), wherein said top plate surface consists of the surface of said plate lacking any materials thus allowing the observations of any structure(s) below the soft magnetic plate (x10) (such as the magnetic-field-generating device (x20) comprising the at least one dipole magnet (x20-a) and/or the non-magnetic holder case (x60) described herein), said observation being carried out from the side of the soft magnetic plate (x10) of the apparatus (x00) or from the side of the coating layer of the assembly (x100). For embodiments wherein the apparatus (x00) comprises the non-magnetic holder case (x60) described herein and as exemplified in FIGS. 4A-P, provided that the indentations (x11), voids (x12) and protrusions (x13), as the case may be, are not filled up with a non-magnetic non-transparent material, the fact that the top plate surface is smaller than the top device surface allows the observations of the non-magnetic holder case (x60) (as depicted in white in FIGS. 4A-P). For embodiments wherein the apparatus (x00) does not comprise the non-magnetic holder case (x60) described herein and provided that the one or more empty volumes defined by the indentations (x11), voids (x12) and protrusions (x13), as the case may be, are not filled up with a non-magnetic non-transparent material, the fact that the top plate surface is smaller than the top device surface allows the observation of the magnetic-field-generating device (x20) (not shown in FIGS. 4A-P).

Due to the presence of the one or more regions free from the soft magnetic plate (x10) described herein, there is a direct interaction of the apparatus described herein with the platelet-shaped magnetic or magnetizable pigment particles of the coating layer” (i.e. not mediated or modified by an intermediate soft magnetic element).

The shape of the soft magnetic plate (x10) is not limited. For example, said soft magnetic plate (x10) may have the shape of a regular polygon (with or without rounded corners), an irregular polygon (with or without rounded corners), a disc, an oval, etc.

The shape of the non-magnetic holder case (x60) is not limited. As an example shown in FIGS. 1C1-1C2, the non-magnetic holder case (x60) has a cross-section having a H-shape, which may be symmetric or asymmetric, preferably an asymmetric H-shape, and comprise a recess (x90-a) for receiving a soft magnetic plate (x10) and an area (x90-b) for receiving the magnetic-field-generating device (x20). According to one embodiment, the soft magnetic plate (x10) is placed on top of the crossbar of the H-shaped non-magnetic holder case (x60) and the magnetic-field-generating device (x20) is placed below the crossbar of the H-shaped non-magnetic holder case (x60). The top surface of the non-magnetic holder case (x60) may by curved in at least one direction so as to be adaptable in or on a rotating cylinder of printing assemblies.

When more than one soft magnetic plates (x10-1, x10-2, x10-3, etc.) are comprised in the apparatus (x00) described herein and as shown for example in FIG. 4B, the top surface of said soft magnetic plates (410-1 and 410-2) comprising one or more indentations (411-1 and 411-2) and/or one or more voids (not shown) and one or more protrusions (not shown), the total surface of said more than one soft magnetic plates (x10-1, x10-2, x10-3, etc.) is smaller than the top device surface of the magnetic-field-generating device (x20) of the apparatus (x00) to allow the observations of any structure(s) below said more than one soft magnetic plates (x10-1, x10-2, x10-3, etc.).

The soft magnetic plate (x10) described herein may additionally be surface-treated for facilitating the contact with the assembly (x100) comprising the substrate (x50) carrying the coating layer (x40) and the apparatus (x00) described herein, reducing corrosion and/or friction and/or wear and/or electrostatic charging in a high-speed printing applications.

According to one embodiment, the soft magnetic plate (x10) described herein carries one or more indicia in the form of one or more protrusions (x13), wherein the one or more regions lacking the one or more protrusions (x13) may be filled up with a non-magnetic material including a polymeric binder such as those described hereabove and optionally fillers.

According to one embodiment, the soft magnetic plate (x10) described herein is flat or planar.

According to another embodiment, the soft magnetic plate described herein (x10) is curved so as to be adaptable in or on a rotating cylinder of printing assemblies.

The soft magnetic plate (x10) described herein comprises one or more soft magnetic materials, i.e. materials having a low coercivity and a high permeability p. Their coercivity is lower than 1000 Am⁻¹ as measured according to IEC 60404-1:2000, to allow for a fast magnetization and demagnetization.

Suitable soft magnetic materials have a maximum relative permeability μ_{R max} of at least 5, where the relative permeability μ_{R} is the permeability of the material p relative to the permeability of the free space μ₀ (μ_{R}=μ/μ₀) (Magnetic Materials, Fundamentals and Applications, 2^{nd} Ed., Nicola A. Spaldin, p. 16-17, Cambridge University Press, 2011). Soft magnetic materials are described, for example, in the following handbooks: (1) Handbook of Condensed Matter and Materials Data, Chap. 4.3.2, Soft Magnetic Materials, p. 758-793, and Chap. 4.3.4, Magnetic Oxides, p. 811-813, Springer 2005; (2) Ferromagnetic Materials, Vol. 1, Iron, Cobalt and Nickel, p. 1-70, Elsevier 1999; (3) Ferromagnetic Materials, Vol. 2, Chap. 2, Soft Magnetic Metallic Materials, p. 55-188, and Chap. 3, Ferrites for non-microwave Applications, p. 189-241, Elsevier 1999; (4) Electric and Magnetic Properties of Metals, C. Moosbrugger, Chap. 8, Magnetically Soft Materials, p. 196-209, ASM International, 2000; (5) Handbook of modern Ferromagnetic Materials, Chap. 9, High-permeability High-frequency Metal Strip, p. 155-182, Kluwer Academic Publishers, 2002; and (6) Smithells Metals Reference Book, Chap. 20.3, Magnetically Soft Materials, p. 20-9-20-16, Butterworth-Heinemann Ltd, 1992.

The soft magnetic plate (x10) described herein may either be a plate made of one or more metals, alloys or compounds of high magnetic permeability (hereafter referred as “soft magnetic metal plate”) or a plate made of a composite comprising soft magnetic particles dispersed in a non-magnetic material (hereafter referred as “soft magnetic composite plate”).

According to one embodiment, the soft magnetic metal plate (x10) described herein is made of one or more soft magnetic metals or alloys easily workable as sheets or threads. Preferably, the soft magnetic metal plate described herein is made from one or more materials selected from the group consisting of iron, cobalt, nickel, nickel-molybdenum alloys, nickel-iron alloys (permalloy or supermalloy-type materials), cobalt-iron alloys, cobalt-nickels alloys iron-nickel-cobalt alloys (Fernico-type materials), Heusler-type alloys (such as Cu₂MnSn or Ni₂MnAl), low silicon steels, low carbon steels, silicon irons (electrical steels), iron-aluminum alloys, iron-aluminum-silicon alloys, amorphous metal alloys (e.g. alloys like Metglas®, iron-boron alloys), nanocrystalline soft magnetic materials (e.g. Vitroperm®) and combinations thereof, more preferably selected from the group consisting of iron, cobalt, nickel, low carbon steels, silicon irons, nickel-iron alloys and cobalt-iron alloys and combinations thereof.

For embodiments wherein the soft magnetic plate (x10) is a soft magnetic metal plate (x10) such as those described herein and comprising the one or more indentations (x11) described herein, said one or more indentations (x11) preferably independently have a depth (D) between about 20% and about 99% in comparison with the thickness (T) of the soft magnetic metal plate (x10), more preferably between about 30% and about 95% in comparison with the thickness (T) of the soft magnetic metal plate (x10), and still more preferably between about 50% and about 90% in comparison with the thickness (T) of the soft magnetic metal plate (x10). The soft magnetic metal plate (x10) comprising the one or more indentations (x11) described herein has preferably a thickness (T) between about 10 μm and about 5000 μm, more preferably between about 50 μm and about 2500 μm, still more preferably between about 50 μm and about 1000 μm.

For embodiments wherein the soft magnetic plate (x10) is a soft magnetic metal plate (x10) such as those described herein and comprising the one or more voids (x12) described herein, said soft magnetic metal plate (x10) preferably has a thickness (T) between about 10 μm and about 5000 μm, more preferably between about 50 μm and about 2500 μm, still more preferably between about 50 μm and about 1000 μm.

For embodiments wherein the soft magnetic plate (x10) is a soft magnetic metal plate (x10) such as those described herein and comprising the one or more protrusions (x13) described herein, said one or more protrusions (x13) preferably independently have a height (H) between 20% and about 10000% in comparison with the thickness (T) of the soft magnetic metal plate (x10), more preferably between about 30% and about 2000% in comparison with the thickness of the soft magnetic metal plate, and still more preferably between about 50% and about 1000% in comparison with the (T) of the soft magnetic metal plate (x10), provided that the sum of the height (H) of the one or more protrusions (x13) and the thickness (T) of the soft magnetic metal plate (x10) is preferably between about 10 μm and about 5000 μm, more preferably between about 50 μm and about 2500 μm, still more preferably between about 50 μm and about 1000 μm. A height (H) of the protrusion (x13) of more than 100% of the (T) of the soft magnetic metal plate (x10) means that the actual height of the protrusion is more than the thickness of the soft magnetic plate (x10) from which the protrusion (x13) projects. For example, a height (H) of 10000% means that the protrusion (x13) has a height of 100 times the thickness of the soft magnetic metal plate (x10) from which it projects.

According to another embodiment, the one or more soft magnetic plates (x10) described herein are made of a composite comprising from about 25 wt-% to about 95 wt-% of soft magnetic particles dispersed in a non-magnetic material, the weight percents being based on the total weight of the one or more soft magnetic plates. Preferably, the composite of the one or more soft magnetic composite plates (x10) comprises from about 50 wt-% to about 90 wt-%, of soft magnetic particles, the weight percents being based on the total weight of the one or more soft magnetic composite plates. The soft magnetic particles described herein are made of one or more soft magnetic materials preferably selected from the group consisting of iron (especially iron pentacarbonyl, also called carbonyl iron), nickel (especially nickel tetracarbonyl, also called carbonyl nickel), cobalt, soft magnetic ferrites (e.g. manganese-zinc ferrites and nickel-zinc ferrites), soft magnetic oxides (e.g. oxides of manganese, iron, cobalt and nickel), soft silicon irons, and combinations thereof, more preferably selected from the group consisting of carbonyl iron, carbonyl nickel, cobalt, soft silicon irons and combinations thereof.

The soft magnetic particles may have a needle-like shape, a platelet-like shape or a spherical shape. Preferably, the soft magnetic particles have a spherical shape so as to maximize the saturation of the soft magnetic composite plate and have the highest possible concentration without losing the cohesion of the soft magnetic composite plate. Preferably, the soft magnetic particles have a spherical shape and have an average particle size (d₅₀) between about 0.1 μm and about 1000 μm, more preferably between about 0.5 μm and about 100 μm, and still more preferably between about 1 μm and 20 about μm, d₅₀ being measured by laser diffraction using for example a microtrac X100 laser particle size analyzer.

The soft magnetic composite plate described herein is made of a composite, wherein said composite comprises the soft magnetic particles described herein dispersed in a non-magnetic material.

Suitable non-magnetic materials include without limitation polymeric materials forming a matrix for the dispersed soft magnetic particles. The polymeric matrix-forming materials may be one or more thermoplastic materials or one or more thermosetting materials or comprise one or more thermoplastic materials or one or more thermosetting materials. Suitable thermoplastic materials include without limitation polyamides, co-polyamides, polyphthalamides, polyolefins, polyesters, polytetrafluoroethylenes, polyacrylates, polymethacrylates (e.g. PMMA), polyimides, polyetherimides, polyetheretherketones, polyaryletherketones, polyphenylene sulfides, liquid crystal polymers, polycarbonates and mixtures thereof. Suitable thermosetting materials include without limitation epoxy resins, phenolic resins, polyimide resins, polyester resins, silicon resins and mixtures thereof. The soft magnetic plate described herein is made of a composite comprising from about 5 wt-% to about 75 wt-% of the non-magnetic material described herein, the weight percents being based on the total weight of the soft magnetic plate.

The composite described herein may further comprise one or more additives such as for example hardeners, dispersants, plasticizers, fillers/extenders and defoamers.

For embodiments wherein the soft magnetic plate (x10) is a soft magnetic composite plate (x10) such as those described herein and comprising the one or more indentations (x11) described herein, said one or more indentations (x11) preferably independently having a depth (D) preferably between about 5% and about 99% in comparison with the thickness (T) of the soft magnetic composite plate (x10), more preferably between about 10% and about 95% in comparison with the thickness (T) of the soft magnetic composite plate (x10), and still more preferably between about 50% and about 90% in comparison with the thickness (T) of the soft magnetic composite plate (x10). The soft magnetic composite plate (x10) comprising the one or more indentations (x11) described herein has preferably a thickness (T) of at least about 500 μm, more preferably at least about 1000 μm and still more preferably between about 1000 μm and about 5000 μm.

For embodiments wherein the soft magnetic plate (x10) is a soft magnetic composite plate (x10) such as those described herein and comprising the one or more voids (x12) described herein, said soft magnetic composite plate (x10) preferably has a thickness (T) of at least about 0.5 mm, more preferably at least about 0.7 mm and still more preferably between about 0.7 mm and about 5 mm.

For embodiments wherein the soft magnetic plate (x10) is a soft magnetic composite plate (x10) such as those described herein and comprising the one or more protrusions (x13) described herein, said one or more protrusions (x13) preferably independently have a height (H) preferably between about 5% and about 10000% in comparison with the thickness (T) the soft magnetic composite plate (x10), more preferably between about 10% and about 2000% comparison with the thickness (T) the soft magnetic composite plate (x10), and still more preferably between about 50% and about 1000% compared with the thickness (T) soft magnetic composite plate (x10), provided that the sum of the height (H) of the one or more protrusions (x13) and the thickness (T) of the soft magnetic composite plate (x10) is preferably of at least about 0.5 mm, more preferably at least about 0.7 mm and still more preferably between about 0.7 mm and about 5 mm. A height of the protrusion (x13) of more than 100% of the thickness (T) of the soft magnetic composite plate (x10) means that the actual height (H) of the protrusion (x13) is more than the thickness (T) of the soft magnetic composite plate (x10) from which the protrusion (x13) projects. For example, a height (H) of 10000% means that the protrusion has a height of 100 times the thickness (T) of the soft magnetic plate from which it projects.

The present invention advantageously uses the soft magnetic composite plates described herein since said plates may be easily produced and treated like any other polymer material. Techniques well-known in the art including 3D printing, lamination molding, compression molding, resin transfer molding or injection molding may be used. After molding, standard curing procedures may be applied, such as cooling down (when thermoplastic polymers are used) or curing at high or low temperature (when thermosetting polymers are used). Another way to obtain the soft magnetic composite plates described herein is to remove parts of them to get the required indentations, voids or protrusions using standard tools to work out plastic parts. Especially, mechanical ablation tools may be advantageously used.

According to one embodiment shown for example in FIG. 4P, the apparatus (x00) described herein may further comprise an engraved magnetic plate (x30), wherein said engraved magnetic plate (x30) comprises one or more engravings (x31), said engraving (x31) preferably having the shape of indicia, wherein the indicia (x31) of the engraved magnetic plate (x30) may be the same as or may be different from the indicia of the soft magnetic plate (x10). The engraved magnetic plate (x30) described herein is placed on top of the first magnetic-field-generating device (x20). As mentioned herein, the fact that the top plate surface is smaller than the top device surface results in one or more regions of the top surface of the apparatus (x00) described herein being free from the soft magnetic plate (x10). According to one embodiment, the engraved magnetic plate (x30) is placed in the one or more regions being free from the soft magnetic plate (x10). Preferably, the top surface of the engraved magnetic plate (x30) is flush with the top surface of the soft magnetic plate (x10) and may partially or fully overlap the one or more regions being free from the soft magnetic plate (x10). FIG. 4P shows an example wherein the engraved magnetic plate (430) comprising the engravings (431) is placed in one or more regions (one region in FIG. 4P) being free the soft magnetic plate (410). The engraved magnetic plate (x30) described herein may be adjacent to or spaced apart from the soft magnetic plate (x10).

The engraved magnetic plate (x30) described herein is made from a permanent magnetic powder material and a polymer. The engraved magnetic plate (x30) described herein may typically be produced by an injection molding process or by metal or laser engraving. Preferred permanent magnetic powder materials include cobalt, iron and their alloys, chromium dioxide, generic magnetic oxide spinels, generic magnetic garnets, generic magnetic ferrites including the hexaferrites such as calcium-, strontium-, and barium-hexaferrite (CaFe12019, SrFe12019, BaFe12019, respectively), generic alnico alloys, generic samarium-cobalt (SmCo) alloys, and generic rare-earth-iron-boron alloys (such as NdFeB), as well as the permanent-magnetic chemical derivatives thereof (such as indicated by the term generic) and mixtures thereof. Plates made of a composite material comprising a polymer and a permanent magnetic powder are obtainable from many different sources, such as from Bomatec, Hbri, CH, ARNOLD® Magnetic Technologies (Plastiform®) or from Materiali Magnetici, Albairate, Milano, IT (Plastoferrite).

The apparatus (x00) described herein comprises the magnetic-field-generating device (x20) comprising the at least one dipole magnet (x20-a). Alternatively, the apparatus (x00) described herein comprises the magnetic-field-generating device (x20) comprising a combination of two or more bar dipole magnets (x20-a1, x20-a2), wherein said magnets have the same magnetic direction. Depending on the required dynamic movement of the optical effect layer (OEL) upon tilting, different magnetic-field-generating devices (x20) may be used.

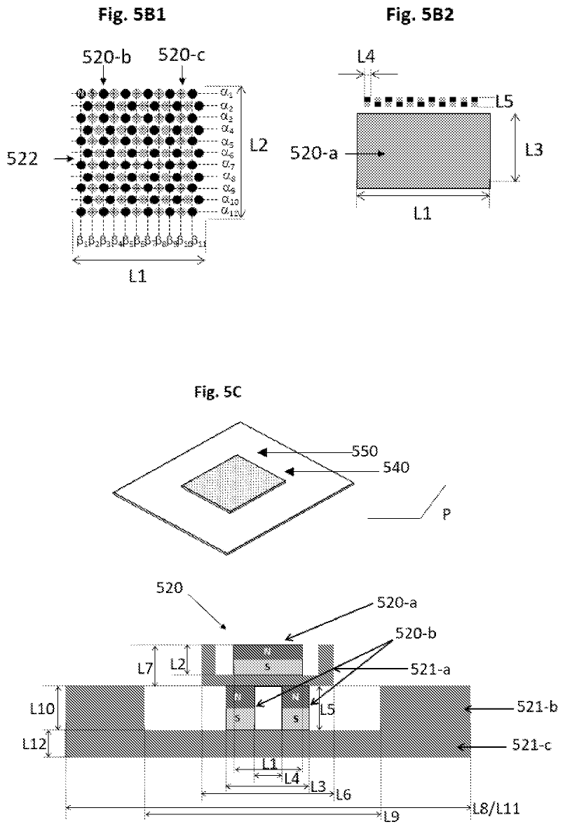

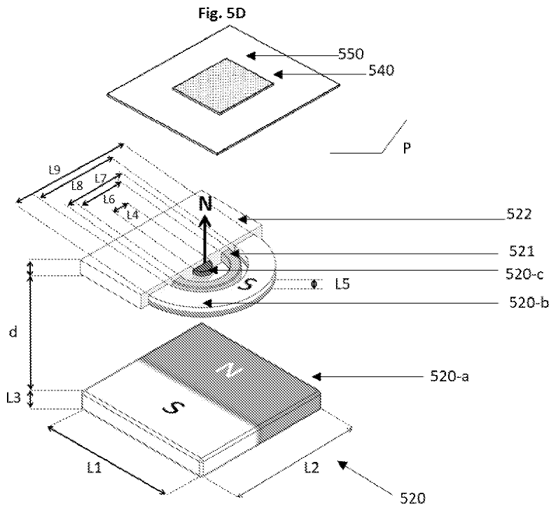

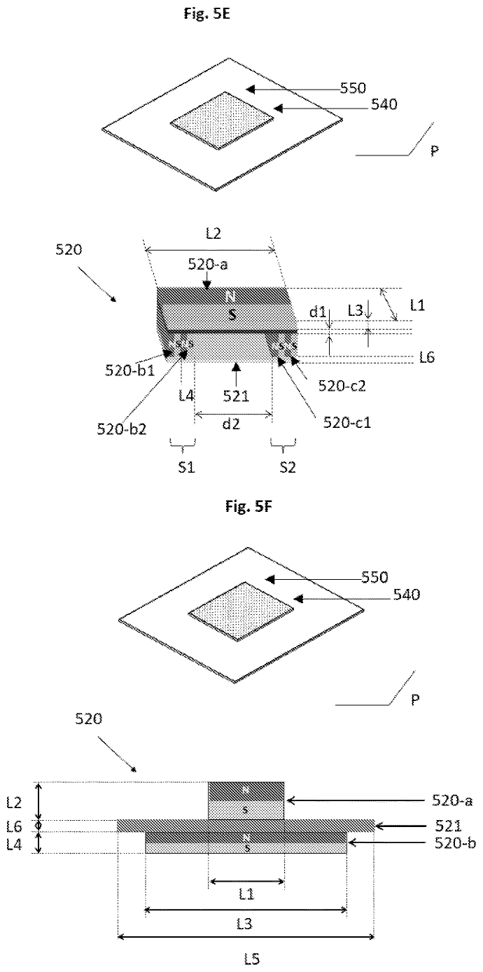

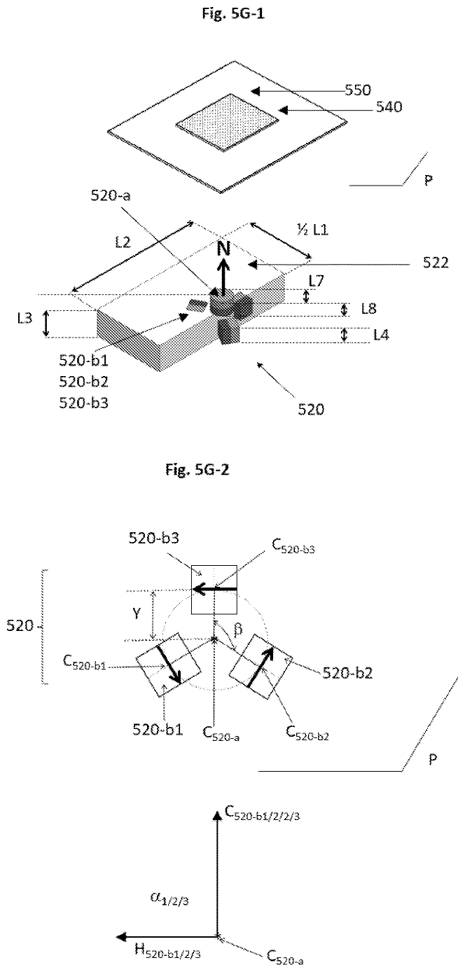

According to one embodiment, wherein the dynamic movement of the optical effect layer (OEL) is a bright reflective horizontal bar moving in a longitudinal direction when the substrate (x50) carrying the OEL is tilted about a longitudinal axis, the at least one dipole magnet (x20-a) of the first magnetic-field-generating device (x20) has a magnetic axis oriented to be substantially parallel to the first plane (P). An example of a suitable first magnetic-field-generating device (x20) for this embodiment is shown in FIG. 5A. This optical effect is the so-called “rolling bar” effect, as disclosed in US 2005/0106367. A “rolling bar” effect is based on pigment particles orientation imitating a curved surface across the coating.

The observer sees a specular reflection zone which moves away or towards the observer as the security feature is tilted.

According to one embodiment, wherein the dynamic movement of the optical effect layer (OEL) is a pattern of bright areas and dark areas moving when the substrate (x50) carrying the OEL is tilted, suitable first magnetic-field-generating devices (x20) are disclosed in WO 2013/167425 A1 and WO 2021/083809 A1. In particular, said first magnetic-field-generating devices (x20) comprise the least at one dipole magnet (x20-a) having a magnetic axis oriented to be substantially parallel to the first plane (P) and a combination comprising at least four additional dipole magnets (x20-b, x20-c) having their North poles pointing in a same direction and having their magnetic axes oriented to be substantially parallel to the first plane (P), said first dipole magnets (x20-b, x20-c) being spaced apart from each other, wherein each of the additional dipole magnets (x20-b, x20-c) is arranged on an intersection of at least two substantially parallel straight lines a, (i=1, 2, . . . ) and at least two substantially parallel straight lines βⱼ (j=1, 2, . . . ), the straight lines αᵢ and βⱼ forming a grid, wherein at least two additional dipole magnets (x20-b, x20-c) are disposed on one of the straight lines a, and at least two other additional dipole magnets (x20-b, x20-c) are disposed on another one of the straight lines αᵢ, wherein the magnetic axes of the additional dipole magnets (x20-b, x20-c) are oriented substantially parallel to the substantially parallel straight lines a, wherein the at least one dipole magnet (x20-a) is disposed below the combination comprising at least four first dipole magnets (x20-b, x20-c). According to one embodiment, each straight line a, and a vector H of the magnetic axis of the at least one dipole magnet (x20-a) is substantially parallel or substantially perpendicular with respect to each other and the OEL exhibits a dynamic movement being a pattern of bright areas and dark areas moving when the substrate (x50) carrying said OEL is tilted, said pattern of bright areas and dark areas moving in the same direction as the tilting direction. According to another embodiment, each straight line a, and a vector H of the magnetic axis of the at least one dipole magnet (x20-a) is substantially non-parallel and substantially non-perpendicular with respect to each other OEL, preferably wherein each straight line a, and the vector sum H of the magnetic axis of the of the at least one dipole magnet (x20-a) form an angle γ in the range from about 20° to about 70° or in the range from about 110° to about 160° or in the range from about 200° to about 250°, or in the range from about 290° to about 340°; and the OEL exhibits a dynamic movement being a pattern of bright areas and dark areas moving not only in a diagonal direction when the substrate (x50) carrying said OEL is tilted about a vertical/longitudinal axis but also moving in a diagonal direction when the substrate carrying said OEL is tilted about a horizontal/latitudinal axis (in other words, the optical effect layer OEL described herein provides the optical impression of a plurality of dark and a plurality of bright spots that are moving when the substrate (x50) carrying said OEL is tilted about two perpendicular axes, i.e. horizontal/latitudinal axis and vertical/longitudinal axis. An example of a suitable first magnetic-field-generating device (x20) for this embodiment is shown in FIG. 5B.

According to a similar embodiment, wherein the dynamic movement of the optical effect layer (OEL) is a pattern of bright areas and dark areas moving when the substrate (x50) carrying the OEL is tilted, suitable first magnetic-field-generating devices (x20) are disclosed in WO 2013/167425 A1 and WO 2021/083808 A1 In particular, said first magnetic-field-generating devices (x20) comprise the at least one dipole magnet (x20-a) having a magnetic axis oriented to be substantially parallel to the first plane (P) and a combination comprising at least four additional dipole magnets (x20-b, x20-c) having their North poles pointing in a same direction and having their magnetic axes oriented to be substantially parallel to the first plane (P), said first dipole magnets (x31) being spaced apart from each other, wherein each of the additional dipole magnets (x20-b, x20-c) is arranged on an intersection of at least two substantially parallel straight lines a, (i=1, 2, . . . ) and at least two substantially parallel straight lines βⱼ (j=1, 2, . . . ), the straight lines a, and 3, forming a grid, wherein at least two additional dipole magnets (x20-b, x20-c) are disposed on one of the straight lines a, and at least two other additional dipole magnets (x20-b, x20-c) are disposed on another one of the straight lines αᵢ, wherein the magnetic axes of the additional dipole magnets (x20-b, x20-c) are oriented substantially parallel to the first plane (P), straight lines a, wherein the at least one dipole magnet (x20-a) is disposed below the combination comprising at least four first dipole magnets (x20-b, x20-c), wherein, on each straight line a, and on each straight line βⱼ, neighboring additional dipole magnets (x20-b, x20-c) have their North pole pointing in an opposite direction, wherein each straight line a, and a vector H of the magnetic axis of the at least one dipole magnet (x20-a) is substantially non-parallel and substantially non-perpendicular with respect to each other OEL, preferably wherein each straight line a, and the vector sum H of the magnetic axis of the of the at least one dipole magnet (x20-a) form an angle γ in the range from about 20° to about 70° or in the range from about 110° to about 160° or in the range from about 200° to about 250°, or in the range from about 290° to about 3400; and the OEL exhibits a dynamic movement being a pattern of bright areas and dark areas moving not only in a diagonal direction when the substrate (x50) carrying said OEL is tilted about a vertical/longitudinal axis but also moving in a diagonal direction when the substrate carrying said OEL is tilted about a horizontal/latitudinal axis (in other words, the optical effect layer OEL described herein provides the optical impression of a plurality of dark and a plurality of bright spots that are moving when the substrate (x50) carrying said OEL is tilted about two perpendicular axes, i.e. horizontal/latitudinal axis and vertical/longitudinal axis).

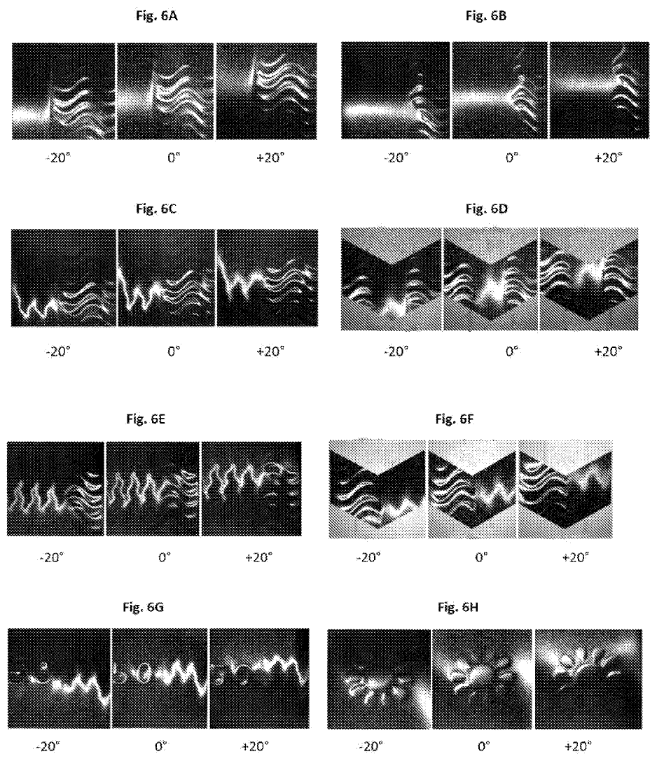

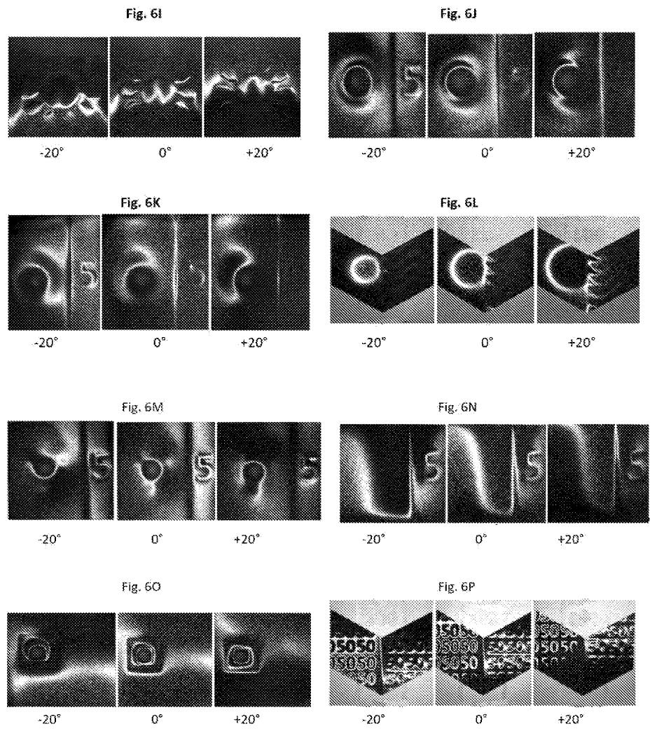

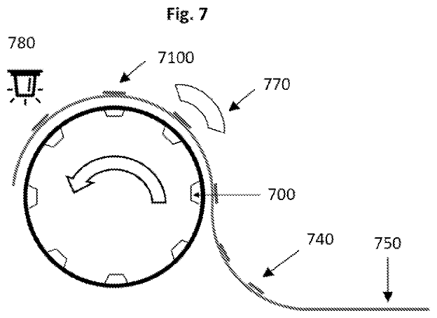

According to one embodiment wherein the dynamic movement of the optical effect layer (OEL) is a loop-shaped body moving when the substrate (x50) carrying said optical effect layer (OEL), suitable magnetic-field-generating devices (x20) are disclosed in WO 2014/108404 A2. In particular, said first magnetic-field-generating devices (x20) comprise either a) the at least one dipole magnet (x20-a) having a magnetic axis oriented to be substantially perpendicular to the first plane (P) and one or more pole pieces (x21), said one or more pole pieces (x21) being disposed below the at least one dipole magnet (x20-a) and in contact with the dipole magnet (x20-a) and/or being spaced apart from and laterally surrounds the at least one dipole magnet (x20-a) (see for example FIGS. 3-5 of WO 2014/108404 A2); b) the at least one dipole magnet (x20-a) being a loop-shaped magnet having a radial magnetization (i.e. having its magnetic North-South axis radially extending from the center of the loop-shaped magnet to the periphery) (see for example FIG. 6 of WO 2014/108404 A2); or c) the at least one dipole magnet (x20-a) being three or more dipole magnets disposed in a loop-shaped arrangement having a radial magnetization (i.e. each of said three or more dipole magnets has its magnetic axis oriented to be substantially parallel to the first plane (P) and has its magnetic axis aligned such as to be substantially radially extending from the center of symmetry of the loop-shaped arrangement, wherein the North-South directions of said three or more dipole magnets point either all towards or all away from the center of symmetry (see for example FIG. 7 of WO 2014/108404 A2).

According to one embodiment wherein the dynamic movement of the optical effect layer (OEL) is a nested multi-loop-shaped body moving when the substrate (x50) carrying said optical effect layer (OEL), suitable magnetic-field-generating devices (x20) are disclosed in WO 2014/108303 A2. In particular, said first magnetic-field-generating devices (x20) comprise either
a) the at least one dipole magnet (x20-a) being a loop-shaped magnet defining a loop and having a magnetic axis oriented to be substantially perpendicular to the first plane (P) and a pole piece (x21) being disposed below the at least one dipole magnet (x20-a) and within the loop of said the at least one dipole magnet (x20-a) and having one or more protrusions disposed within the loop of the at least one dipole magnet (x20-a) (see for example FIGS. 3-5 of WO 2014/108303 A2); or
b) the at least one dipole magnet (x20-a) having a magnetic axis oriented to be substantially perpendicular to the first plane (P), an additional dipole magnet (x20-b) having a magnetic axis oriented to be substantially perpendicular to the first plane (P) and two or more pole pieces (x21-a, x21-b), wherein said at least one dipole magnet (x20-a) and additional magnet (x20-b) have the same magnetic direction and are provided in different distances from the first plane (P), wherein said two or more pole pieces (x21-a, x21-b) are arranged in the space between the magnets (x20-a and x20-b) and in contact therewith and wherein at least one of the two or more pole pieces form one or more loop-shaped projections surrounding a central area in which the at least one dipole magnet is arranged (x20-a) (see for example FIGS. 6a, 6b and 6d of WO 2014/108303 A2); or
c) the at least one dipole magnet (x20-a) having a magnetic axis oriented to be substantially perpendicular to the first plane (P), a plate-like-shaped pole piece (x21-a) being disposed below and in contact with the at least one dipole magnet (x20-a), and one or more loop-shaped pole pieces (x21-b) being disposed on top the at least one dipole magnet (x20-a), wherein a central pole piece of said one or more loop-shaped pole pieces (x21-b) is in contact with the at least one dipole magnet (x20-a), and wherein said plate-like-shaped pole piece (x21-a) may comprise one or more protrusions laterally and spaced apart surrounding the at least one dipole magnet (x20-a) (see for example FIGS. 7a-7d of WO 2014/108303 A2). An example of a suitable first magnetic-field-generating device (x20) for this embodiment is shown in FIG. 5C.

According to one embodiment wherein the dynamic movement of the optical effect layer (OEL) is a loop-shaped body having a size that varies when the substrate (x50) carrying said OELs is tilted suitable magnetic-field-generating devices (x20) are disclosed in WO 2017/064052 A1, WO 2017/080698A1 and WO 2017/148789 A1. In particular, said first magnetic-field-generating devices (x20) comprises one of the following:
a) the at least one dipole magnet (x20-a) being either a single bar dipole magnet (x20-a) having a North-South magnetic axis substantially parallel to first plane (P) or a combination of two or more bar dipole magnets (x20-al, x20-a2) having a resulting North-South magnetic axis substantially parallel to the first plane (P) and b) a loop-shaped magnetic-field generating device (x20-b) being either a single loop-shaped dipole magnet (x20-b) having a North-South magnetic axis substantially perpendicular to the first plane (P) or a combination of two or more dipole magnets (x20-b1, x20-b2) disposed in a loop-shaped arrangement and having a resulting North-South magnetic axis substantially perpendicular to the first plane (P) (see for example FIGS. 1-4 of WO 2017/064052 A1), or
a) the at least one dipole magnet (x20-a) being either a single dipole magnet (x20-a) having a magnetic axis substantially parallel to the first plane (P) or a combination of two or more bar dipole magnets (x20-al, x20-a2), each of the two or more bar dipole magnets (x20-al, x20-a2) having a magnetic axis substantially parallel to the first plane (P) and having a same magnetic field direction, b) a loop-shaped magnetic-field generating device (x20-b) being either a single loop-shaped dipole magnet (x20-b) having a magnetic axis substantially perpendicular to the first plane (P) or a combination of two or more dipole magnets (x20-b1, x20-b2) disposed in a loop-shaped arrangement, each of the two or more dipole magnets (x20-b1, x20-b2) having a magnetic axis substantially perpendicular to the first plane (P) and having a same magnetic field direction, and c) a single dipole magnet (x20-c) having a magnetic axis substantially perpendicular to the first plane (P) or two or more dipole magnets (x20-cl, x20-c2), each of the two or more dipole magnets (x20-cl, x20-c2) having a magnetic axis substantially perpendicular to the first plane (P) and having a same magnetic field direction and/or one or more pole pieces (x21) (see for example FIGS. 1-12 of WO 2017/080698 A1), or
a) the at least one dipole magnet (x20-a) being either a single bar dipole magnet (x20-a) having a magnetic axis substantially parallel to the first plane (P) or a combination of two or more bar dipole magnets (x20-al, x20-a2), each of the two or more bar dipole magnets (x20-al, x20-a2) having a magnetic axis substantially parallel to the first plane (P) and having a same magnetic field direction, b) a loop-shaped magnetic-field generating device (x20-b) being either a single loop-shaped magnet (x20-b) or a combination of two or more dipole magnets (x20-b1, x20-b2), disposed in a loop-shaped arrangement, the loop-shaped magnetic-field generating device(x20-b) having a radial magnetization, and c) a single dipole magnet (x20-c) having a magnetic axis substantially perpendicular to the first plane (P) or a single dipole magnet (x20-c) having a magnetic axis substantially parallel to the first plane (P), or two or more dipole magnets (x20-cl, x20-c2), each of said two or more dipole magnets (x20-cl, x20-c2)having a magnetic axis substantially perpendicular to the first plane (P), wherein the North pole of said single dipole magnet (x20-c) or the North pole of at least one of said two or more dipole magnets (x20-cl, x20-c2) is pointing towards the substrate (x50) surface when the North pole of the single loop-shaped magnet (x20-b) or of the two or more dipole magnets (x20-b1, x20-b2) forming the loop-shaped magnetic-field generating device is pointing towards the periphery of said loop-shaped magnetic-field generating device (x20-b), or wherein the South pole of said single dipole magnet (x20-c) or the South pole of at least one of said two or more dipole magnets (x20-c1, x20-c2) is pointing towards the first plane (P) when the South pole of the single loop-shaped magnet (x20-b) or of the two or more dipole magnets (x20-b1, x20-b2) forming the loop-shaped magnetic-field generating device is pointing towards the periphery of said loop-shaped magnetic-field generating device (x20-b) (see for example FIGS. 1-14 of WO 2017/148789 A1). An example of a suitable first magnetic-field-generating device (x20) for this embodiment is shown in FIG. 5D.

According to one embodiment wherein the dynamic movement of the optical effect layer (OEL) is a bright reflective vertical bar moving in a longitudinal direction when the substrate (x50) carrying said OEL is tilted about a horizontal/latitudinal axis or moving in a horizontal/latitudinal direction when the substrate carrying said OEL is tilted about a longitudinal axis, suitable first magnetic-field-generating devices (x20) are disclosed in WO 2020/160993 A1. In particular, said first magnetic-field-generating devices (x20) comprises a) the at least one dipole magnet (x20-a) being a square-shaped or rectangle-shaped dipole magnet (x20-a) having its magnetic axis oriented to be substantially parallel to the first plane (P) and b) a combination of n sets of spaced apart bar dipole magnets (x20-b1, x20-b2) with n being an integer equal to or bigger than 1, wherein each of said bar dipole magnets (x20-b1, x20-b2) has its North-South magnetic axis substantially parallel to the substrate (x50) surface and to the first plane (P), wherein, for each set of said n sets, the bar dipole magnets (x20-b1, x20-b2) have their North pole pointing in a same direction and are substantially parallel to each other; wherein the vector sum H1 of the magnetic axes of the bar dipole magnets (x20-b1, x20-b2) and the vector sum H2 of the at least one dipole magnet (x20-a) form an angle α in the range from about 5° to about 175° or in the range from about 185° to about 355°, preferably in the range from about 60° to about 120° or in the range from about 240° to about 300°; wherein the combination of n sets of spaced apart bar dipole magnets (x20-bi, x20-b2) is placed below or on top of the second least one dipole magnet (x20-a), and wherein the at least one dipole magnet (x20-a) and combination of n sets of spaced apart bar dipole magnets (x20-bi, x20-b2) are essentially centered with respect to one another (see for example FIGS. 2-5 of WO 2020/160993 A1). An example of a suitable first magnetic-field-generating device (x20) for this embodiment is shown in FIG. 5E.

According to one embodiment wherein the dynamic movement of the optical effect layer (OEL) is a moon crescent moving and rotating when the substrate (x50) carrying said optical effect layer (OEL) is tilted an suitable first magnetic-field-generating devices (x20) are disclosed in WO 2019/215148 A1.

In particular, said first magnetic-field-generating devices (x20) comprises a) the at least one dipole magnet (x20-a) being a first dipole magnet (x20-a) having its North-South magnetic axis substantially perpendicular to the substrate (x20) surface and having length L1, b) a second dipole magnet (x20-b) having its North-South magnetic axis substantially perpendicular to the first plane (P) and having a length L3, and c) a flat pole piece (x21) lacking any protrusions or projections extending outside the surface of said pole piece and having a length L5, wherein the first dipole magnet (x20-a) and the second dipole magnet (x20-b) have a same magnetic field direction, wherein the first dipole magnet (x20-a) faces the substrate (x50) and is disposed on top of the flat pole piece (x21), wherein the second dipole magnet (x20-b) faces the environment and is disposed below the flat pole piece (x21), wherein the length L1 of the first dipole magnet (x20-a) is smaller than the length L3 of the second dipole magnet (x20-b), wherein the length L1 of the first dipole magnet (x20-a) is smaller than the length L5 of the flat pole piece (x21), and wherein the length L3 of the second dipole magnet (x20-b) is smaller than the length L5 of the pole piece (x21) (see for example FIGS. 1-12 of WO 2017/148789 A1). An example of a suitable first magnetic-field-generating device (x20) for this embodiment is shown in FIG. 5F.

According to one embodiment, wherein the dynamic movement of the optical effect layer (OEL) is a loop-shaped body surrounded by one or more loop-shaped bodies, wherein said one or more one or more loop-shaped bodies have their shape and/or their brightness varying when the substrate (x50) carrying said OELs is tilted, suitable first magnetic-field-generating devices (x20) are disclosed in WO 2020/193009 A1. In particular, said first magnetic-field-generating devices (x20) comprises a) a combination of three or more first dipole magnets x20-bi (x20-b1, x20-b2, x20-b3, . . . ), each of said first dipole magnets having its center C_{x20-bi} (C_{x20-b1}, C_{x20-b2}, C_{x20-b3}, . . . ) disposed on a loop in the first plane (P), wherein said first dipole magnets x20-bi (x20-b1, x20-b2, x20-b3, . . . ) have their magnetic axes oriented to be substantially parallel to the first plane (P) and b) the at least one dipole magnet (x20-a) having its magnetic axis oriented to be substantially perpendicular to the first plane (P) and being arranged to have a projection of its center on the first plane (P) be located at a projection point Cₓ₂₀₋ₐ within the loop, wherein the at least one dipole magnet (x20-a) is disposed above the combination of three or more first dipole magnets (x20-b1, x20-b2 and x20-b3), wherein angles αᵢ are formed between each of the vectors \vec{Cₓ₂₀₋ₐC_{x20-bι}} (\vec{Cₓ₂₀₋ₐC_{x20-b1}}, \vec{Cₓ₂₀₋ₐC_{x20-b2}}, Cₓ₂₀₋ₐC_{x20-b3}) and the vector \vec{h_{x20-bι}} (\vec{h_{x20-b1}}, \vec{h_{x20-b2}}, \vec{h_{x20-b3}}, . . . ) of the magnetic axis of the respective first dipole magnet x20-bi (x20-b1, x20-b2, x20-b3, . . . ), wherein all of the angles αᵢ, when measured in a counterclockwise direction, are in the range from about 200 to about 1600 or in the range from about 2000 to about 340°, and wherein each of the first dipole magnets x20-bi (x20-b1, x20-b2, x20-b3, . . . ) is disposed at a first distance (Y,), said first distance (Y,) being on the first plane (P) between the projection point Cₓ₂₀₋ₐ and the center C_{x20-bi} (C_{x20-b1}, C_{x20-b2}, C_{x20-b3}, . . . ) of the first dipole magnet x20-bi (x20-b1, x20-b2, x20-b3, . . . ) (see for example FIGS. 2-9 of in WO 2020/193009 A1). According to one embodiment, the at least one dipole magnet (x20-a) and the combination of three or more first dipole magnets (x20-b1, x20-b2 and x20-b3) are arranged in such a way that at least two, preferably all, angles βᵢ are equal to each other, wherein said angles βᵢ are respectively formed between the vectors \vec{Cₓ₂₀₋ₐC_{x20-by}} and \vec{C_{x21-b}C_{x20-(b+1)}}, i.e. the angles formed between the straight lines from the projection point (Cₓ₂₀₋ₐ) to the respective center (C_{x20-b1}, C_{x20-b2}, . . . ) of adjacent (but not necessarily in direct contact) dipole magnets (x20-b1, x20-b2, . . . ). An example of a suitable first magnetic-field-generating device (x20) for this embodiment is shown in FIGS. 5G.

The assembly (x100) comprising the substrate (x50) carrying the coating layer (x40) and the apparatus (x00) described herein is moved through the inhomogeneous magnetic field of the static second magnetic-field-generating device (x70) as described herein so that the platelet-shaped magnetic or magnetizable pigment particles are exposed to a magnetic field which is at least time-varying in direction thus bi-axially orienting at least part of said platelet-shaped magnetic or magnetizable pigment particles while the coating composition is still in a wet (i.e. not yet hardened) state.

The distance d-c (shown in FIG. 1B) between the coating layer (x40) and the second magnetic-field-generating device (x70) is adjusted and selected to obtain the desired optical effect layers.

The movement of said assembly (x100) within the magnetic field of the static second magnetic-field-generating device (x70) must allow the magnetic field vector, as described in the reference frame of the substrate, to vary essentially within a single plane at individual locations on the substrate. This can be achieved by rotational oscillations, by complete (3600 or more) rotation of the assembly (x100), preferably by a back and forth translational movement along a path, more preferably by a translational movement in a single direction along a path. Particularly preferable are single translational movements that follow a linear or cylindrical path. The soft magnetic plate (x10) described herein acts as a magnetic field guide, very close to the coating composition, when placed into the magnetic field of the external static second magnetic-field-generating device (x70), hence deviating the magnetic field from its original direction. At the place of the indentations (x11), voids (x12) and/or protrusions (x13), the direction and intensity of the magnetic field lines are locally modified so as to cause the orientation of the platelet-shaped magnetic or magnetizable pigment particles to locally change compared to the orientation of the pigment particles that are further away from said indentations or protrusions. This in turn generates, in addition to the dynamic appearance described herein, the desired eye-catching relief and 3D effect.

Contrary to a mono-axial orientation wherein the platelet-shaped magnetic or magnetizable pigment particles are orientated in such a way that only one of their main axis (the longer one) is constrained by the magnetic field vector, carrying out a bi-axial orientation means that the platelet-shaped magnetic or magnetizable pigment particles are made to orient in such a way that both their two main axes are constrained. Such biaxial orientation is achieved, according to the invention, by exposing and moving the assembly (x100) comprising the substrate (x50) carrying the coating layer (x40) and the apparatus (x00) to and through the inhomogeneous magnetic field of the second static magnetic-field generating device (x70). Accordingly, said static magnetic-field generating device must be configured in such a way that, along the path of motion followed by individual platelet-shaped magnetic or magnetizable pigment particles of the coating layer, the magnetic field lines change at least in direction within a plane which is fixed in the reference frame of the moving assembly (x100). Bi-axial orientation aligns the planes of the platelet-shaped magnetic or magnetizable pigment particles so that said planes are oriented to be locally substantially parallel to each other.

According to one embodiment, the step of carrying out a bi-axial orientation of the platelet-shaped magnetic or magnetizable pigment particles leads to a magnetic orientation wherein the platelet-shaped magnetic or magnetizable pigment particles have their two main axes substantially parallel to the substrate (x50) surface and to the first plane (P) except in the regions carrying indentations, voids or protrusions and in the regions submitted to the influence of the magnetic field of the first magnetic-field-generating device (x20). For such an alignment, the platelet-shaped magnetic or magnetizable pigment particles are planarized within the coating layer on the substrate and are oriented with both their axis parallel with the substrate surface, except in the regions carrying the one or more indentations or protrusions where a wider range of angles is covered.

According to another embodiment, the step of carrying a bi-axial orientation of at least a part of the platelet-shaped magnetic or magnetizable pigment particles leads to a magnetic orientation wherein the platelet-shaped magnetic or magnetizable pigment particles have a first main axis substantially parallel to the substrate (x50) surface and to the first plane (P) and a second main axis being perpendicular to said first axis at a substantially non-zero elevation angle to the substrate (x50) surface and to the first plane (P) except in the regions carrying indentations, voids or protrusions and in the regions submitted to the influence of the magnetic field of the first magnetic-field-generating device (x20), where a wider range of angles is covered. Alternatively, the platelet-shaped magnetic or magnetizable pigment particles have their two main axes X and Y at a substantially non-zero elevation angle to the substrate (x50) surface and to the first plane (P) except in the regions carrying indentations, voids or protrusions and in the regions submitted to the influence of the magnetic field of the first magnetic-field-generating device (x20), where a wider range of angles is covered. This is achieved when, seen along the path of motion, the angle between the magnetic field lines of the magnetic-field-generating device vary within a plane that forms a non-zero angle with respect to a plane tangential to the surface of assembly (x100) comprising the substrate (x50) carrying the coating layer (x40) and the apparatus (x00).

Suitable magnetic-field generating devices (x70) for bi-axially orienting the platelet-shaped magnetic or magnetizable pigment particles described herein are not limited.

Bi-axial orientation of the platelet-shaped magnetic or magnetizable pigment particles may be carried out by moving the assembly (x100) comprising the substrate (x50) carrying the coating layer (x40) and the apparatus (x00) at an appropriate speed through the magnetic field of the magnetic-field-generating device (x70) such as those described in EP 2 157 141 A1. Such devices provide a magnetic field that changes its direction while the platelet-shaped magnetic or magnetizable pigment particles move through said devices, forcing the platelet-shaped magnetic or magnetizable pigment particles to rapidly oscillate until both main axes, X-axis and Y-axis, become parallel to the substrate (x50) surface and to the first plane (P), i.e. the platelet-shaped magnetic or magnetizable pigment particles oscillate until they come to the stable sheet-like formation with their X and Y axes parallel to the substrate (x50) surface and to the first plane (P) and are planarized in said two dimensions. As shown in FIG. 5 of EP 2 157 141, the magnetic-field-generating device described (x70) herein comprises a linear arrangement of at least three magnets that are positioned in a staggered fashion or in zigzag formation, said at least three magnets being on opposite sides of a feedpath where magnets at the same side of the feedpath have the same polarity, which is opposed to the polarity of the magnet(s) on the opposing side of the feedpath in a staggered fashion. The arrangement of the at least three magnets provides a predetermined change of the field direction as platelet-shaped magnetic or magnetizable pigment particles in a coating composition move past the magnets (direction of movement: arrow). According to one embodiment, the magnetic-field-generating device (x70) comprises a) a first magnet and a third magnet on a first side of a feedpath and b) a second magnet between the first and third magnets on a second opposite side of the feedpath, wherein the first and third magnets have a same polarity and wherein the second magnet has a complementary polarity to the first and third magnets. According to another embodiment, the magnetic-field-generating device (x70) further comprises a fourth magnets on the same side of the feedpath as the second magnet, having the polarity of the second magnet and complementary to the polarity of the third magnet. As described in EP 2 157 141 A1, the magnetic-field-generating device (x70) can be either underneath the layer comprising the platelet-shaped magnetic or magnetizable pigment particles, or above and underneath.

Bi-axial orientation of the platelet-shaped magnetic or magnetizable pigment particles may be carried out by moving the assembly (x100) comprising the substrate (x50) carrying the coating layer (x40) and the apparatus (x00) at an appropriate speed through the magnetic field of the magnetic-field-generating device (x70) described in EP 1 519 794 B1. Suitable devices (x70) include permanent magnets being disposed on each side of the assembly (x100) surface, above or below it, such that the magnetic field lines are substantially parallel to the assembly (x100) surface.

Bi-axial orientation of the platelet-shaped magnetic or magnetizable pigment particles may be carried out by moving the assembly (x100) comprising the substrate (x50) carrying the coating layer (x40) and the apparatus (x00) at an appropriate speed through the magnetic field of the magnetic-field-generating device (x70) consisting of linear permanent magnet Halbach arrays, i.e. devices comprising a plurality of magnets with different magnetization directions and cylinder devices. Detailed description of Halbach permanent magnets was given by Z. Q. Zhu and D. Howe (Halbach permanent magnet machines and applications: a review, IEE. Proc. Electric Power Appl., 2001, 148, p. 299-308). The magnetic field produced by such a magnetic-field-generating device (x70) consisting of a Halbach array has the properties that it is concentrated on one side while being weakened almost to zero on the other side. Linear Halbach arrays are disclosed for example in WO 2015/086257 A1 and WO 2018/019594 A1 and Halbach cylinder devices are disclosed in EP 3 224 055 B1.

Bi-axial orientation of the platelet-shaped magnetic or magnetizable pigment particles may be carried out by moving the assembly (x100) comprising the substrate (x50) carrying the coating layer (x40) and the apparatus (x00) at an appropriate speed through the magnetic field of the magnetic-field-generating device (x70) consisting of a spinning magnet, said magnet comprising one or more disc-shaped spinning magnets or magnetic-field generating devices that are essentially magnetized along their diameter. Suitable magnetic-field-generating device (x70) consisting of spinning magnets or magnetic-field generating devices are described in US 2007/0172261 A1, said spinning magnets or magnetic-field generating devices generating radially symmetrical time-variable magnetic fields, allowing the bi-axial orientation of pigment particles of a not yet cured coating composition. These magnets or magnetic-field generating devices are driven by a shaft (or spindle) connected to an external motor. CN 102529326 B discloses examples of magnetic-field-generating device (x70) comprising spinning magnets that might be suitable for bi-axially orienting pigment particles. In a preferred embodiment, suitable magnetic-field-generating device (x70) are shaft-free disc-shaped spinning magnets or magnetic-field generating devices constrained in a housing made of non-magnetic, preferably non-conducting, materials and are driven by one or more magnet-wire coils wound around the housing. Examples of such shaft-free disc-shaped spinning magnets or magnetic-field generating devices are disclosed in WO 2015/082344 A1, WO 2016/026896 A1 and WO2018/141547 A1.

Bi-axial orientation of the platelet-shaped magnetic or magnetizable pigment particles may be carried out by moving the assembly (x100) comprising the substrate (x50) carrying the coating layer (x40) and the apparatus (x00) at an appropriate speed through the magnetic field of the magnetic-field-generating device (x70) comprising a) at least a first set (S1) and a second set (S2), each of the first and second sets (S1, S2) comprising one first bar dipole magnet having its magnetic axis oriented to be substantially parallel to the substrate during the magnetic orientation and two second bar dipole magnets having their magnetic axes oriented to be substantially perpendicular to the substrate; and b) a pair (P1) of third bar dipole magnets having their magnetic axes oriented to be substantially parallel to the substrate such as those disclosed in WO 2021/239607 A1.

The process for producing the OEL described herein comprises partially simultaneously with step c) or subsequently to step c), preferably partially simultaneously, a step of hardening (step d)) the coating composition. The step of hardening the coating composition allows the platelet-shaped magnetic or magnetizable pigment particles to be fixed in their adopted positions and orientations in a desired pattern to form the OEL, thereby transforming the coating composition to a second state. However, the time from the end of step c) to the beginning of step d) is preferably relatively short in order to avoid any de-orientation and loss of information. Typically, the time between the end of step c) and the beginning of step d) is less than 1 minute, preferably less than 20 seconds, further preferably less than 5 seconds.

It is particularly preferable that there is essentially no time gap between the end of the orientation step c) and the beginning of the curing step d), i.e. that step d) follows immediately after step c) or already starts while step c) is still in progress (partially simultaneously). By “partially simultaneously”, it is meant that both steps are partly performed simultaneously, i.e. the times of performing each of the steps partially overlap. In the context described herein, when hardening is performed partially simultaneously with the step c), it must be understood that hardening becomes effective after the orientation so that the platelet-shaped magnetic or magnetizable pigment particles orient before the complete or partial hardening of the OEL. As mentioned herein, the hardening step (step d)) may be performed by using different means or processes depending on the binder material comprised in the coating composition that also comprises the platelet-shaped magnetic or magnetizable pigment particles.

The hardening step generally may be any step that increases the viscosity of the coating composition such that a substantially solid material adhering to the substrate is formed. The hardening step may involve a physical process based on the evaporation of a volatile component, such as a solvent, and/or water evaporation (i.e. physical drying). Herein, hot air, infrared or a combination of hot air and infrared may be used. Alternatively, the hardening process may include a chemical reaction, such as a curing, polymerizing or cross-linking of the binder and optional initiator compounds and/or optional cross-linking compounds comprised in the coating composition. Such a chemical reaction may be initiated by heat or IR irradiation as outlined above for the physical hardening processes, but may preferably include the initiation of a chemical reaction by a radiation mechanism including without limitation Ultraviolet-Visible light radiation curing (hereafter referred as UV-Vis curing) and electronic beam radiation curing (E-beam curing); oxypolymerization (oxidative reticulation, typically induced by a joint action of oxygen and one or more catalysts preferably selected from the group consisting of cobalt-containing catalysts, vanadium-containing catalysts, zirconium-containing catalysts, bismuth-containing catalysts and manganese-containing catalysts); cross-linking reactions or any combination thereof.

Radiation curing is particularly preferred, and UV-Vis light radiation curing is even more preferred, since these technologies advantageously lead to very fast curing processes and hence drastically decrease the preparation time of any article comprising the OEL described herein. Moreover, radiation curing has the advantage of producing an almost instantaneous increase in viscosity of the coating composition after exposure to the curing radiation, thus minimizing any further movement of the particles. In consequence, any loss of orientation after the magnetic orientation step can essentially be avoided. Particularly preferred is radiation-curing by photo-polymerization, under the influence of actinic light having a wavelength component in the UV or blue part of the electromagnetic spectrum (typically 200 nm to 650 nm; more preferably 200 nm to 420 nm). Equipment for UV-visible-curing may comprise a high-power light-emitting-diode (LED) lamp, or an arc discharge lamp, such as a medium-pressure mercury arc (MPMA) or a metal-vapor arc lamp, as the source of the actinic radiation.

The process for producing the OEL described herein may further comprise a step e) of releasing or separating the substrate (x50) carrying the so-obtained OEL from the soft magnetic plate (x10).

The present invention provides the processes to produce the optical effect layers (OELs) on the substrate (x50) described herein. The substrate described herein is preferably selected from the group consisting of papers or other fibrous materials (including woven and non-woven fibrous materials), such as cellulose, paper-containing materials, glasses, metals, ceramics, plastics and polymers, metallized plastics or polymers, composite materials and mixtures or combinations of two or more thereof. Typical paper, paper-like or other fibrous materials are made from a variety of fibers including without limitation abaca, cotton, linen, wood pulp, and blends thereof. As is well known to those skilled in the art, cotton and cotton/linen blends are preferred for banknotes, while wood pulp is commonly used in non-banknote security documents. Typical examples of plastics and polymers include polyolefins such as polyethylene (PE) and polypropylene (PP) including biaxially oriented polypropylene (BOPP), polyamides, polyesters such as poly(ethylene terephthalate) (PET), poly(1,4-butylene terephthalate) (PBT), poly(ethylene 2,6-naphthoate) (PEN) and polyvinylchlorides (PVC). Spunbond olefin fibers such as those sold under the trademark Tyvek® may also be used as substrate. Typical examples of metalized plastics or polymers include the plastic or polymer materials described hereabove having a metal disposed continuously or discontinuously on their surface. Typical examples of metals include without limitation aluminum (AI), chromium (Cr), copper (Cu), gold (Au), silver (Ag), alloys thereof and combinations of two or more of the aforementioned metals. The metallization of the plastic or polymer materials described hereabove may be done by an electrodeposition process, a high-vacuum coating process or by a sputtering process. Typical examples of composite materials include without limitation multilayer structures or laminates of paper and at least one plastic or polymer material such as those described hereabove as well as plastic and/or polymer fibers incorporated in a paper-like or fibrous material such as those described hereabove. Of course, the substrate can comprise further additives that are known to the skilled person, such as fillers, sizing agents, whiteners, processing aids, reinforcing or wet strengthening agents, etc. When the OELs produced according to the present invention are used for decorative or cosmetic purposes including for example fingernail lacquers, said OEL may be produced on other type of substrates including nails, artificial nails or other parts of an animal or human being.

Should the OEL produced according to the present invention be on a security document, and with the aim of further increasing the security level and the resistance against counterfeiting and illegal reproduction of said security document, the substrate may comprise printed, coated, or laser-marked or laser-perforated indicia, watermarks, security threads, fibers, planchettes, luminescent compounds, windows, foils, decals and combinations of two or more thereof. With the same aim of further increasing the security level and the resistance against counterfeiting and illegal reproduction of security documents, the substrate may comprise one or more marker substances or taggants and/or machine readable substances (e.g. luminescent substances, UV/visible/IR absorbing substances, magnetic substances and combinations thereof).

If desired, a primer layer may be applied to the substrate (x50) prior to the step a). This may enhance the quality of the OEL described herein or promote adhesion. Examples of such primer layers may be found in WO 2010/058026 A2.

With the aim of increasing the durability through soiling or chemical resistance and cleanliness and thus the circulation lifetime of an article, a security document or a decorative element or object comprising the OEL obtained by the process described herein, or with the aim of modifying their aesthetical appearance (e.g. optical gloss), one or more protective layers may be applied on top of the OEL. When present, the one or more protective layers are typically made of protective varnishes. These may be transparent or slightly colored or tinted and may be more or less glossy. Protective varnishes may be radiation curable compositions, thermal drying compositions or any combination thereof.

Preferably, the one or more protective layers are radiation curable compositions, more preferable UV-Vis curable compositions. The protective layers are typically applied after the formation of the OEL.

The present invention further provides optical effect layers (OEL) produced by the process according to the present invention.

The optical effect layer (OEL) described herein may be provided directly on a substrate on which it shall remain permanently (such as for banknote applications). Alternatively, an optical effect layer (OEL) may also be provided on a temporary substrate for production purposes, from which the OEL is subsequently removed. This may for example facilitate the production of the optical effect layer (OEL), particularly while the binder material is still in its fluid state. Thereafter, after hardening the coating composition for the production of the optical effect layer (OEL), the temporary substrate may be removed from the OEL.

Alternatively, in another embodiment an adhesive layer may be present on the optical effect layer (OEL) or may be present on the substrate comprising OEL, said adhesive layer being on the side of the substrate opposite to the side where the OEL is provided or on the same side as the OEL and on top of the OEL. Therefore, an adhesive layer may be applied to the optical effect layer (OEL) or to the substrate (x50), said adhesive layer being applied after the curing step has been completed. Such an article may be attached to all kinds of documents or other articles or items without printing or other processes involving machinery and rather high effort. Alternatively, the substrate described herein comprising the optical effect layer (OEL) described herein may be in the form of a transfer foil, which can be applied to a document or to an article in a separate transfer step. For this purpose, the substrate is provided with a release coating, on which the optical effect layer (OEL) is produced as described herein. One or more adhesive layers may be applied over the so produced optical effect layer (OEL).

Also described herein are substrates comprising more than one, i.e. two, three, four, etc. optical effect layers (OEL) obtained by the process described herein.

Also described herein are articles, in particular security documents, decorative elements or objects, comprising the optical effect layer (OEL) produced according to the present invention. The articles, in particular security documents, decorative elements or objects, may comprise more than one (for example two, three, etc.) OELs produced according to the present invention.

As mentioned hereabove, the optical effect layer (OEL) produced according to the present invention may be used for decorative purposes as well as for protecting and authenticating a security document.

Typical examples of decorative elements or objects include without limitation luxury goods, cosmetic packaging, automotive parts, electronic/electrical appliances, furniture and fingernail articles.

Security documents include without limitation value documents and value commercial goods.

Typical examples of value documents include without limitation banknotes, deeds, tickets, checks, vouchers, fiscal stamps and tax labels, agreements and the like, identity documents such as passports, identity cards, visas, driving licenses, bank cards, credit cards, transactions cards, access documents or cards, entrance tickets, public transportation tickets or titles and the like, preferably banknotes, identity documents, right-conferring documents, driving licenses and credit cards. The term “value commercial good” refers to packaging materials, in particular for cosmetic articles, nutraceutical articles, pharmaceutical articles, alcohols, tobacco articles, beverages or foodstuffs, electrical/electronic articles, fabrics or jewelry, i.e. articles that shall be protected against counterfeiting and/or illegal reproduction in order to warrant the content of the packaging like for instance genuine drugs. Examples of these packaging materials include without limitation labels, such as authentication brand labels, tamper evidence labels and seals. It is pointed out that the disclosed substrates, value documents and value commercial goods are given exclusively for exemplifying purposes, without restricting the scope of the invention.

Alternatively, the optical effect layer (OEL) may be produced onto an auxiliary substrate such as for example a security thread, security stripe, a foil, a decal, a window or a label and consequently transferred to a security document in a separate step.

The skilled person can envisage several modifications to the specific embodiments described above without departing from the spirit of the present invention. Such modifications are encompassed by the present invention.

Further, all documents referred to throughout this specification are hereby incorporated by reference in their entirety as set forth in full herein.

### EXAMPLES

The present invention is now described in more details with reference to non-limiting examples. The Examples below provide more details for suitable apparatuses and magnetic-field-generating devices for the production of optical effects layers (OELs).

A UV-curable screen printing composition comprising platelet-shaped magnetic or magnetizable pigment particles has been prepared and is described in Table 1.

Combinations of i) an apparatus (x00) comprising a soft magnetic plate (x10) carrying one or more indicia in the form of one or more indentations (x11) and/or one or more voids (x12) and/or one or more protrusions (x13) shown in FIG. 4 and a first magnetic-field-generating device (x20) shown in FIG. 5 with ii) a second magnetic-field-generating device (x70) shown in FIG. 3 have been used to produce optical effect layers (OELs) comprising magnetically oriented platelet-shaped magnetic or magnetizable pigment particles on a commercial paper substrate (x50) (a fiduciary standard paper BNP 100 g/m², from Papierfabrik Louisenthal, 80×70 mm). The so-obtained OELs are shown in FIGS. 6.

TABLE 1

| | | |
|---|---|---|
| Epoxyacrylate oligomer | 36 | wt-% |
| Trimethylolpropane triacrylate monomer | 13.5 | wt-% |
| Tripropyleneglycol diacrylate monomer | 20 | wt-% |
| Genorad ™ 16 (Rahn) | 1 | wt-% |
| Aerosil ® 200 (Evonik) | 1 | wt-% |
| Speedcure TPO-L (Lambson) | 2 | wt-% |
| IRGACURE ® 500 (BASF) | 6 | wt-% |
| Genocure EPD (Rahn) | 2 | wt-% |
| Tego ® Foamex N (Evonik) | 2 | wt-% |
| optically variable platelet-shaped | 16.5 | wt-% |
| magnetic pigment particles (7 layers)(*) | | |

(*)gold-to-jade optically variable magnetic pigment particles having a flake shape of diameter d50 about 9 μm and thickness about 1 μm, obtained from Viavi Solutions, Santa Rosa, CA.

The UV-curable screen printing ink described in Table 1 was independently applied onto the substrate (x50) described hereabove (step a) of the method described herein), said application being carried out by hand screen printing using a T90 screen so as to form a coating layer (x40) (a square-shaped coating layer of 25 mm×25 mm (FIGS. 6A, 6J and 6N), a square-shaped coating layer of 30 mm×30 mm (FIGS. 6B, 6C, 6E, 6H, 6I, 6M and 6O); a square-shaped coating layer of 35 mm×35 mm (FIGS. 6G and 6K); or a V-shaped coating layer of 22 mm×14 mm (FIGS. 6D, 6F, 6L, 6P) having a thickness of about 20 μm. As shown for example in FIGS. 1A-B, the substrate (x50) carrying the coating layer (x40) was disposed on an apparatus (x00) comprising a non-magnetic holder case (x60), a first magnetic-field-generating device (x20) and a soft magnetic plate (x10) carrying one or more indicia (x11 and/or x12 and/or x13) so as to form an assembly (x100) (step b) of the method described herein). As shown in FIGS. 1A-B, the so-obtained assembly (x100) was moved at a speed of about 1 m/sec in the vicinity and below a static second magnetic-field-generating device (x70) (step c) of the method described herein) with the coating layer (x40) facing the second magnetic-field-generating device (x70), the distance d-c between the coating layer (x40) and the second magnetic-field-generating device (x70) being about 5 mm. Immediately after having moved the assembly (x100) under the second magnetic-field-generating device (x70), the coating layer (x40) was at least partially cured at a distance of about 35 mm from the end of the second magnetic-field-generating device (x70) using a UV-LED-lamp from Phoseon (Type FireFlex 25×10 mm, 395 nm, 4 W/cm²). Pictures of the so-obtained optical effect layers (OELs) are shown in FIG. 6 at different substrate (x50) viewing angles.

A) Apparatuses (x00)

The apparatuses (x00) used to prepare the optical effect layers (OELs) on the substrate (x50) described herein comprised a non-magnetic holder case (x60) schematically in FIG. 1C1 and 1C2 and having a H-shape cross-section (dimensions: 40 mm×40 mm and the height and crossbar being adjusted to have the distance d-a provided in Table 3) having a curved surface in one direction, a soft magnetic plate (x10) described in Table 2 and shown in FIG. 4 and a magnetic-field-generating device (x20) shown in illustrated in FIGS. 5, wherein said apparatuses (x00) were configured for receiving the substrate (x50) in an orientation parallel to a first plane (P) and above the first plane (P), said first plane (P) being substantially parallel to the substrate (x50) surface during the preparation process.

### A1. Soft Magnetic Plates 410 (See FIGS. 4A1-2, 4B, 4D, 4H, 4M, 4O and 4P)

The soft magnetic plates (410) (from Bomatec, Hbri, CH) shown in FIGS. 4A1-2, 4B, 4D, 4H, 4M, 4O and 4P were made of FeSi₃ granules (Catamold® FeSi₃ from BASF, soft magnetic iron-silicon alloy having a coercivity Hc=73 Am⁻¹ and a permeability μ_{Rmax}=5215) injected at about 80 wt-% in polyoxymethylene (POM).

TABLE 2

| | | | T | |
|---|---|---|---|---|
| | length | width | (thickness) | D (depth) and width (W) of the indentations/voids/ |
| ×10 | mm | mm | mm | protrusions |
| 410 in FIG. 4A1 | 37 | 20 | 1 | 9 wave-shaped indentations 411 (D: 0.7 mm, W: 0.4 mm) |
| 410 in FIG. 4A2 | 37 | 20 | 1 | 9 wave-shaped protrusions 414 (H: 0.8 mm, W: 0.4 mm) |
| 410-½ in FIG. 4B* | 37 | 15 | 1 | two set of 9 wave-shaped indentations 411-1 and 411-2 |
| | | | | (D: 0.7 mm, W: 0.4 mm) |
| 410 in FIG. 4D | 37 | 10 | 1 | 5-shaped (6 mm × 9 mm) void 412 (W: 1 mm) or 50-shaped |
| | | | | void 412 (W: 1 mm) |
| 410 in FIG. 4H | 37 | 16-20 | 1 | 9 wave-shaped indentations 411 (D: 0.7 mm, W: 0.4 mm) |
| 410 in FIG. 4M | 37 | 37 | 1 | centrally aligned disc-shaped void (W: 17 mm) and 10 |
| | | | | petal-shaped indentations 411 (D: 0.8 mm, W: 3 mm) |
| | | | | symmetrically disposed around the disc-shaped void 412 |
| 410 in FIG. 4O | 10 | 10 | 1 | square-shaped void 412 (W: 5 mm) comprising a |
| | | | | cylindrical bar dipole magnet 414 (diameter: 4 mm and |
| | | | | thickness: 9 mm, made of NdFeB N42) having its |
| | | | | magnetic axis perpendicular to the substrate (×50) |
| | | | | surface and to the first plane (P) with the South Pole |
| | | | | facing the substrate (×50) arranged and glued in the |
| | | | | center of the void 412 with its top surface being flushed |
| | | | | with the top surface of the plate 410 |
| 410 in FIG. 4P | 37 | 10 | 1 | 50-shaped (4 mm × 3 mm) indentations 411 (D: 0.9 mm, |
| | | | | W: 0.4 mm)*** |

*the two soft magnetic plates 410-1 and 410-2 were spaced apart by about 7 mm.
** an engraved magnetic plate (430) made of plasto-hardferrite (supplier = Bomatec, Höri, CH) and produced by injection molding was used in combination with the soft magnetic plate (410), wherein said engraved magnetic plate (430) (38 mm × 19 mm × 1 mm) comprised 50-shaped (4 mm × 3 mm) indentations 431 (D: 0.4 mm, W: 0.4 mm) and was placed beside the soft magnetic plate (410) with its top surface being flush with the top surface of the soft magnetic plate (410).

### A2. Magnetic-Field-Generating Devices 520 (FIG. 5)

### First Magnetic-Field-Generating Device of FIGS. 5A (Top View: 5A1 and Cross-Section: 5A2)

The first magnetic-field-generating device (520) illustrated in FIG. 5A was a bar dipole magnet (520-a) having the following dimensions: a length (L1) of about 29.9 mm, a width (L2) of about 29.9 mm, a thickness (L3) of about 2 mm (E1-E2, E8, E15-E16). The first magnetic-field-generating device (520-a) had a magnetic axis substantially parallel to its length and substantially parallel to the substrate (550) surface and to the first plane (P). The bar dipole magnet (520-a) was made of NdFeB N52.

First magnetic-field-generating device of Figs SB (top view: 51B1 and cross-section: 51B2)

The first magnetic-field-generating device was similar to the first magnetic-field-generating device disclosed in FIG. 6A of WO 2021/083809 A1.

The first magnetic-field-generating device in Figs SB comprised a bar dipole magnet (520-a) and 121 dipole magnets (520-b and 520-c) embedded in a square-shaped non-magnetic supporting matrix (522).

The bar dipole magnet (520-a) had the following dimensions: a length (L1) of about 29.9 mm, a width (L2) of about 29.9 mm, a thickness (L3) of about 6.9 mm. The bar dipole magnet (520-a) had a magnetic axis substantially parallel to its length and substantially parallel to the substrate (x50) surface (not shown) and to the first plane (P). The bar dipole magnet (520-a) was made of compressed plasto-NdFeB GMP13 L grade BMNpi-80/48 (from Bomatec, Hbri, CH).

Each of the 121 dipole magnets (520-b and 520-c) was a cylinder having a diameter (L4) of about 2 mm and a thickness (L5) of about 2 mm and having a magnetic axis parallel to the thickness (L5) and perpendicular to the substrate (x50) surface and to the first plane (P). The 121 dipole magnets (520-b and 520-c) were made of NdFeB N48.

The square-shaped supporting matrix (522) had a length of about 29.9 mm, a width of about 29.2 mm and a thickness of about 3 mm. The square-shaped supporting matrix (522) was made of POM. The square-shaped supporting matrix (522) comprised 121 indentations for receiving the 121 dipole magnets (520-b and 520-c).

The 121 dipole magnets (520-b and 520-c) were embedded in the indentations of the supporting matrix (522),wherein eleven sets comprising each eleven of said 121 dipole magnets (520-b and 520-c) were arranged on eleven substantially parallel straight lines α₁₋₁₁, wherein of each of said dipole magnets (520-b and 520-c) arranged on an uneven-numbered straight lines αᵢ (that is the dipole magnets arranged on the lines (α₁, α₃, α₅, α₇, α₉ and α₁₁) were arranged at the intersections of a grid comprising the eleven substantially parallel straight lines α₁₋₁₁ and eleven parallel straight lines β₁₋₁₁.

The straight lines α₁₋₁₁ were parallel with respect to each other, the straight lines βⱼ were parallel with respect to each other and the straight lines α, were perpendicular to the straight lines β₁₋₁₁. The eleven lines α₁₋₁₁ and the eleven lines β₁₋₁₁ were equally spaced apart and neighboring lines were separated by a distance of about 2.5 mm.

Each of said 121 dipole magnets (520-b and 520-c) arranged on an even-numbered straight lines α, (i.e. the dipole magnets arranged on the lines (α₂, α₄, α₆, α₈ and α₁₀) were arranged between two neighboring straight lines βⱼ as illustrated in FIG. 5B1.

On each of the eleven straight lines αᵢ and on each of the eleven straight lines βᵢ, the dipole magnets (520-b and 520-c) were spaced apart and separated by a distance of 0.5 mm. On each of the eleven straight lines αᵢ and on each of the eleven straight lines βᵢ, the dipole magnets (520-b) and the magnets (520-c) were disposed alternatively, i.e. they were disposed with alternating North or South poles facing the substrate (550), the first and the last dipole magnets on each straight lines being a dipole magnet (520-b) having its North pole facing the substrate (550).

Each straight line a1-11 was substantially perpendicular with respect to the vector H of the first magnetic-field generating device (520-a) (not shown in FIGS. 5B).

The bar dipole magnet (520-a) and the square-shaped supporting matrix (522) carrying the 121 dipole magnets (520-b and 520-c) were spaced apart by a distance of about 0.2 mm.

### First Magnetic-Field-Generating Device of FIG. 5C (Cross Section in the Symmetric Plan of 520)

The first magnetic-field-generating device of FIG. 5C was similar to the first magnetic-field-generating device disclosed in FIG. 6a of WO 2014/108303 A1.

The first magnetic-field-generating device (520) of FIG. 5C comprised a disc-shaped dipole magnet (520-a), a ring-shaped dipole magnet (520-b) and three pole pieces (521-a, 521-b and 521-c).

The disc-shaped dipole magnet (520-a) had a diameter (L1) of about 5 mm and a thickness (L2) of about 2 mm, a magnetic axis perpendicular to its diameter and perpendicular to the substrate (550) surface and to the first plane (P) with its North pole pointing toward the substrate, and was made of NdFeB N48.

The ring-shaped dipole magnet (520-b) had an external diameter (L3) of about 6 mm, an internal diameter (L4) of about 2 mm and a thickness (L5) of about 2 mm, a magnetic axis perpendicular to its diameter, parallel to the magnetic axis of the disc-shaped dipole magnet (520-a) and perpendicular to the substrate (550) surface and to the first plane (P), with its North pole pointing toward the substrate (520) and was made of NdFeB N48.

The pole piece (521-a) had an external diameter (L6) of about 10 mm and a thickness(L7) of about 3 mm. The pole piece (521-a) comprised a recess having a diameter of about 8 mm and a thickness (depth of the recess) of about 2 mm. The pole piece (521-b) was a ring-shaped pole piece and had an external diameter (L8) of about 30 mm, an internal diameter (L9) of about 17 mm and a thickness (L10) of about 3 mm. The pole piece (521-c) was a disc-shaped pole piece having a diameter (L11) of about 30 mm, and a thickness (L12) of about 2 mm. The three pole pieces (521-a, 521-b and 521-c) were made of steel S235.

The disc-shaped dipole magnet (520-a) was disposed in the recess of the pole piece (521-a) so that its uppermost surface was flush with the uppermost surface of the pole piece (521-a). The pole piece (521-a) was disposed on the ring-shaped dipole magnet (520-b). The ring-shaped dipole magnet (520-b) and the pole piece (521-b) were disposed on the pole piece (521-c), so that the dipole magnet (520-b) was flush with the upper surface of the pole piece (521-b). The dipole magnets (520-a and 520-b) and the pole pieces (521-a, 521-b and 521-c) were centrally aligned.

### First Magnetic-Field-Generating Device of FIG. 5D (Oblique View)

The first magnetic-field-generating device of FIG. 5D was similar to the first magnetic-field-generating device disclosed in FIG. 11 of WO 2017/080698 A1 (except that the magnet x40 was a single bar dipole).

The first magnetic-field-generating device (520) of FIG. 5D comprised three dipole magnets (520-a, 520-b and 520-c) and a pole piece (521).

The dipole magnet (520-a) had a length (L2) of about 30 mm, a width (L1) of about 30 mm and a thickness (L3) of about 5 mm. The magnetic axis of the dipole magnet (520-a) was substantially parallel to the substrate (550) surface and to the first plane (P). The dipole magnet (520-a) was made of NdFeB N30.

The dipole magnet (520-b) was a ring-shaped dipole magnet having an internal diameter (L6) of about 17 mm, an external diameter (L7) of about 25 mm, and a thickness (L5) of about 2 mm. The magnetic axis of the dipole magnet (520-b) was substantially perpendicular to the substrate (550) surface and to the first plane (P) with its South pole pointing towards the substrate (550). The dipole magnet (520-b) was made of NdFeB N45.

The dipole magnet (520-c) was a cylindrical dipole magnet having a diameter (L4) of about 4 mm and a thickness (L5) of about 2 mm. The magnetic axis of the dipole magnet (520-c) was substantially perpendicular to the substrate (550) surface and to the first plane (P) with its North pole pointing towards the substrate (550). The dipole magnet (520-c) was made of NdFeB N45.

The pole piece (521) was a ring-shaped pole piece having an internal diameter (L8) of about 10 mm, an external diameter (L9) of about 14 mm, and a thickness (L5) of about 2 mm. The pole piece (521) was of iron.

The dipole magnets (520-b and 520-c) and the pole piece (521) were embedded in a square-shaped non-magnetic supporting matrix (522) made of POM (30 mm×30 mm×3 mm) and comprising recesses for receiving the dipole magnets (520-b and 520-c) and the pole piece (521).

The dipole magnet (520-b), the ring-shaped pole piece (521) and the supporting matrix (522) were centrally aligned along the length and the width of the non-magnetic supporting matrix (522). The dipole magnet (520-c) was asymmetrically disposed at distance of about 1 mm from the edge of the internal diameter of the pole piece (521).

The supporting matrix (522) and the embedded dipole magnets (520-b and 520-c) and the ring-shaped pole piece (521) was spaced apart from the dipole magnet (520-a), i.e. the distance d between the lower surface of supporting matrix (522) and the upper surface of the dipole magnet (520-a) was about 1 mm.

### First Magnetic-Field-Generating Device of FIG. 5E (Oblique View)

The first magnetic-field-generating device of FIG. 5E was similar to the first magnetic-field-generating device disclosed in FIG. 3 of WO 2020/160993 A1.

The first magnetic-field-generating device (520) of FIG. 5E comprises five dipole magnets (520-a, 520-b1, 520-b2, 520-cl and 520-c2) and a pole piece (521).

The dipole magnet (520-a) had a length (L1) of about 30 mm, a width (L2) of about 30 mm and a thickness (L3) of about 2 mm. The magnetic axis of the dipole magnet (520-a) was substantially parallel to the length (L1) and substantially parallel the substrate (550) surface and to the first plane (P).

The dipole magnet (520-a) was made of NdFeB N30.

Each of the dipole magnets (520-b1, 520-b2, 520-cl and 520-c2) had a length (L1) of about 30 mm, a width (L4) of about 3 mm and a thickness (L5) of about 6 mm. The magnetic axis of each the dipole magnets (520-b1, 520-b2, 520-cl and 520-c2) was substantially parallel to the width (L4) and substantially parallel to the substrate (550) surface and to the first plane (P). Each the dipole magnets (520-b1, 520-b2, 520-cl and 520-c2) was made of NdFeB N45.

The dipole magnets (520-b1, 520-b2, 520-cl and 520-c2) were arranged as two sets (S1 and S2) comprising each two dipole magnets (S1: 520-b1 and 520-b2; S2: 520-cl and 520-c2), spaced apart by a distance (d2) of 18 mm (d2 being equal to the width (L2) minus 4 times the width (L4); i.e. d2=L2 (4×L4)), each of the two sets being formed by the juxtaposition of two dipole magnets ((S1: 520-b1 and 520-b2; S2: 520-cl and 520-c2) along their length, as illustrated in FIG. 5E.

The pole piece (521) had a length (L1) of about 30 mm, a width (L2) of about 30 mm and a thickness (L6) of about 1 mm. The pole piece (521) was made of iron.

The dipole magnet (520-a) was placed on top of the two sets of each two dipole magnets (S1 and S2) at a distance (d1) of about 1 mm; the two sets of each two dipole magnets (S1 and S2) were placed on top of and in direct contact with the pole piece (521); i.e. the two sets of each two dipole magnets (S1 and S2) were placed between the dipole magnet (520-a) and the pole piece (521).

### First Magnetic-Field-Generating Device of FIG. 5F (Cross Section in the Symmetric Plan of 520)

The first magnetic-field-generating device of FIG. 5F was similar to the first magnetic-field-generating device disclosed in FIG. 1 of WO 2019/215148 A1.

The first magnetic-field-generating device (520-a) of FIG. 5F comprised two bar dipole magnets (520-a and 520-b) and a pole piece (521), wherein said bar dipole magnet (520-a) was disposed on top of and in direct contact with said pole piece (521), the pole piece (521) was disposed on top of and in direct contact with said bar dipole magnet (520-b). Both of said bar dipole magnets (520-a and 520-b) had their North-South magnetic axis substantially perpendicular to the substrate (550) surface and to the first plane (P) with the North pole pointing towards the substrate (550).

The bar dipole magnet (520-a) had a diameter (L1) of 5 mm and a thickness (L2) of 3 mm. The bar dipole magnet (520-b) had a diameter (L3) of 20 mm and a thickness of (L4) 2 mm. The bar dipole magnets (520-a and 520-b) were made of NdFeB N30.

The pole piece (521) had a diameter (L5) of about 30 mm and a thickness (L6) of about 6 mm and was made of iron.

### First Magnetic-Field-Generating Device of FIGS. 5G (Oblique and Top Views)

The first magnetic-field-generating device of FIG. 5G was the first magnetic-field-generating device disclosed in Example 1 and FIG. 2 of WO 2020/193009 A1.

The first magnetic-field-generating device (520) of FIG. 5G comprised a cylindrical dipole magnet (520-a) and three cubic dipole magnets (520-b1, 520-b2 and 520-b3), said three cubic dipole magnets (520-b1, 520-b2 and 520-b3), being embedded in a supporting matrix (522).

The three cubic first dipole magnets (520-b1, 520-b2 and 520-b3) had the side-length (L4) of about 3 mm and were made of NdFeB N45.

As shown in FIGS. 5G, the three cubic first dipole magnets (520-b1, 520-b2 and 520-3) were arranged in such a way that each center (C_{520-b1}, C_{520-b2} and C_{520-b3}) was disposed on a ring in the plane (P) being substantially parallel to the substrate (550) surface and to the first plane (P). The three cubic dipole magnets (520-b1, 520-b2 and 520-3) had their magnetic axes substantially parallel to the substrate (550) surface and to the first plane (P) and substantially perpendicular to the magnetic axis of the cylindrical dipole magnet (520-a). The three cubic dipole magnets (520-b1, 520-b2 and 520-b3) had their North pole pointing all in the same circular direction (i.e. counterclockwise circular direction).

The supporting matrix (522) had a length (L2) of about 30 mm, a width (L1) of about 30 mm and a thickness L3 of about 5.5 mm, was made of POM and comprised three indentations for holding the three cubic first dipole magnets (520-b1, 520-b2 and 520-3), said indentations having the same shape and dimensions as the three cubic first dipole magnets (520-b1, 520-b2 and 520-b3) so that the uppermost surface of the three cubic first dipole magnets (520-b1, 520-b2 and 520-b3) was flush with the uppermost surface of the supporting matrix (522).

The dipole magnet (520-a) had a diameter (L7) of 4 mm and a thickness (L8) of 3 mm. The bar dipole magnet (520-a) was made of NdFeB N44 and had its magnetic axis substantially perpendicular to the substrate (550) surface and to the first plane (P) with its North pole pointing towards (i.e. facing) the substrate (550). The dipole magnet (520-a) was disposed in direct contact and above the supporting matrix (522). The center of the dipole magnet (520-a) was centrally aligned with the center of the ring formed by the three cubic dipole magnets (520-b1, 520-b2 and 520-b3) and centrally aligned with the supporting matrix (522).

The projection of the center of the dipole magnet (520-a) on the plane (P) was located at the projection point (C₅₂₀₋ₐ) and was symmetrically disposed within the ring, i.e. the projection point (C₅₂₀₋ₐ) also corresponded to the center of the symmetric ring.

The three angles α_{1/2/3} respectively formed by i) the vectors \vec{C₅₂₀₋ₐC_{520-b1}} \vec{C₅₂₀₋ₐC_{520-b2}}, \vec{C₅₂₀₋ₐC_{520-b3}} (i.e. the vectors between the projection point (C₅₂₀₋ₐ) and the center (C_{520-b1}, C_{520-b2} and C_{520-b3}) of each respective cubic dipole magnets (520-b1, 520-b2, 520-b3) and ii) the vectors (\vec{h_{520-b1}}, \vec{h_{520-b2}}, \vec{h_{520-b3}}, when measured in a counterclockwise direction, were equal to each other, in particular 90°, i.e. the three cubic dipole magnets (520-b1, 520-b2, 520-b3) had their magnetic axes substantially tangential to the ring at the position of their respective center (C_{520-b1}, C_{520-b2} and C_{520-b3}).

The three cubic dipole magnets (520-b1, 520-b2, 520-b3) were evenly distributed around the projection point (C₅₂₀₋ₐ) of the dipole magnet (520-a). The three angles β respectively formed by the vectors \vec{C₅₂₀₋ₐC_{520-b1}} (corresponding to the straight line from the projection point (C₅₂₀₋ₐ) to the center C_{520-b1} of the cubic first dipole magnet (250-b1)) and \vec{C₅₂₀₋ₐC_{520-b2}}; the vectors \vec{C₅₂₀₋ₐC_{520-b1}} and \vec{C₅₂₀₋ₐC_{520-b2}}; and the vectors \vec{C₅₂₀₋ₐC_{520-b2}} and \vec{C₅₂₀₋ₐC_{520-b3}} were equal to each other, in particular 120°.

The center of the dipole magnet (520-a) and the center of the combination of the cubic dipole magnets (520-b1, 520-b2, 520-b3) were substantially centered with respect to one another and were substantially centered with respect to the projection point (C₅₂₀₋ₐ) of the center of the dipole magnet (520-a). The distances Y between the projection point (C₅₂₀₋ₐ) of the center of the dipole magnet (520-a) and the center (C_{520-b1}, C_{520-b2} and C_{520-b3}) of each of said three cubic first dipole magnets (520-b1, 520-b2, 520-b3) were equal to each other, said distances Y being about 4.5 mm.

### B) Second Static Second Magnetic-Field-Generating Device 270 (FIG. 2)

The second magnetic-field-generating device (270) used to bi-axially orient the pigment particles according to the method of the present invention comprised a) a first set (S1) comprising a first bar dipole magnet (271-a) and two second bar dipole magnets (272-a and 272-d), a second set (S2) comprising a first bar dipole magnet (271-b) and two second bar dipole magnets (272-b and 272-e) and a third set (S3) comprising a first bar dipole magnet (271-c) and two second bar dipole magnets (272-c and 272-f), and b) a first pair (P1) of third bar dipole magnets (273-a and 273-b) and a second pair (P2) of third bar dipole magnets (273-c and 273-d).

The upmost surface of the first bar dipole magnet (271-a, 271-b and 271-c) of the first, second and third sets (S1, S2, S3), of the second bar dipole magnets (272-a to 272-f) of the first, second and third sets (S1, S2, S3) and of the third bar dipole magnets (273-a, 273-b, 273-c and 273-d) of the first and second pairs (P1 and P2) were flush with each other.

The third bar dipole magnet (273-a) was aligned with the second bar dipole magnet (272-a) of the first set (S1), with the second bar dipole magnet (272-b) of the second set (S2), with the third bar dipole magnet (273-c) and with the second bar dipole magnet (272-c) of the third set (S3) so as form a line. The third bar dipole magnet (273-b) was aligned with the second bar dipole magnet (272-d) of the first set (S1), with the second bar dipole magnet (272-e) of the second set (S2), with the third bar dipole magnet (273-d) and with the second bar dipole magnet (272-f) of the third set (S3) so as form a line. For each line described herein, the third bar dipole magnets (273a, 273-b, 273-c and 273-d) and the second bar dipole magnets (272-a to 272-f) were spaced apart by a third distance (d2) of 2 mm. The first bar dipole magnet (271-a) of the first set (S1) and the first bar dipole magnet (271-b) of the second set (S2), and the first bar dipole magnet (271-c) of the third set (S3) were spaced apart by a distance (d3) of 24 mm.

The first bar dipole magnets (271-a, 271-b and 271-c) of the first, second and third sets (S1, S2, S3) had the following dimensions: first length (L1) of 60 mm, first width (L2) of 40 mm and first thickness (L3) of 5 mm. Each of the second bar dipole magnets (272-a to 272-f) of the first, second and third set (S1, S2, S3) had the following dimensions: second length (L4) of 40 mm, second width (L5) of 10 mm and second thickness (L6) of 10 mm. Each of the third bar dipole magnets (273-a, 273-b and 273-c) of the first and second pairs (P1, P2) had the following dimensions: third length (L7) of 20 mm, third width (L8) of 10 mm and third thickness (L9) of 10 mm.

The first bar dipole magnet (271-a) of the first set (S1) and the second bar dipole magnets (272-a and 272-d) of the first set (S1) were aligned to form a column; and the first bar dipole magnet (271-b) of the second set (S2) and the second bar dipole magnets (272-b and 272-e) of the second set (S2) were aligned to form a column; and the first bar dipole magnet (271-c) of the third set (S3) and the second bar dipole magnets (272-c and 272-f) of the third set (S3) were aligned to form a column. For each set (S1, S2, S3) and each column described herein, the first bar dipole magnets (271-a, 271-b and 271-c) and the two second bar dipole magnets (272-a and 272-d; 27-b and 272-e; and 272-c and 272-f, respectively) were spaced apart by a second distance (d1) of 2 mm.

The first bar dipole magnets (271-a, 271-b and 271-c) of the first, second and third sets (S1, S2, S3) had their magnetic axis oriented to be substantially parallel to the first plane and substantially parallel to the substrate (250) surface and to the first plane (P), wherein the first bar dipole magnet (271-a) of the first set (S1) had its magnetic direction opposite to the magnetic direction of the first bar dipole magnet (271-b) of the second set (S2), and the first bar dipole magnet (271-b) of the second set (S2) had its magnetic direction opposite to the magnetic direction of the first bar dipole magnet (271-c) of the third set (S3). The first bar dipole magnet (271-a) of the first set (S1) and first bar dipole magnet (271-b) of the second set (S2), as well as the first bar dipole magnet (271-b) of the second set (S2) and the first bar dipole magnet (271-c) of the third set (S3), were spaced apart by a first distance (d3) of 24 mm (corresponding to the sum of the third length (L7) and the two third distances (d2)).

The two second bar dipole magnets (272-a to 272-f) of the first, second and third set (S1, S2, S3) had their magnetic axis oriented to be substantially perpendicular to the substrate (250) surface and to the first plane (P). The South pole of the second bar dipole magnet (272-a) of the first set (S1), the South pole of the second bar dipole magnet (272-e) of the second set (S2) and the South pole of the second bar dipole magnet (272-c) of the third set (S3) pointed towards the first plane (P) and towards the substrate (250). The North pole of the second bar dipole magnet (272-d) of the first set (S1), the North pole of the second bar dipole magnet (272-b) of the second set (S2) and the North pole of the second bar dipole magnet (272-f) of the third set (S3) pointed towards the first plane (P) and towards the substrate (250). The North pole of the first bar dipole magnet (271-a) of the first set (S1) pointed towards the second bar dipole magnet (272-d) of the first set (S1), the North pole of the second bar dipole magnet (271-b) of the second set (S2) pointed towards the first bar dipole magnet (272-b) of the second set (S2) and the North pole of the first bar dipole magnet (271-c) of the third set (S3) pointed towards the second bar dipole magnet (272-f) of the third set (S3). The South pole of the third bar dipole magnet (273-a) of the first pair (P1) pointed towards the second bar dipole magnet (272-a) of the first set (S1), said second bar dipole magnet (272-a) having its South pole pointing towards the substrate (250) and towards the first plane (P); the South pole of the third bar dipole magnet (273-d) of the second pair (P1) pointed towards the second bar dipole magnet (272-e) of the second set (S2), said second bar dipole magnet (272-e) having its South pole pointing towards the substrate (250) and towards the first plane (P); the North pole of the third bar dipole magnet (273-b) of the first pair (P1) pointed towards the second bar dipole magnet (272-d) of the first set (S1), said second bar dipole magnet (272-d) having its North pole pointing towards the substrate (250) and towards the first plane (P); and the North pole of the third bar dipole magnet (273-c) of the second pair (P2) pointed towards the second bar dipole magnet (272-b) of the second set (S2), said second bar dipole magnet (272-b) having its North pole pointing towards the substrate (250) and towards the first plane (P).

The first bar dipole magnets (271-a, 271-b and 271-c) of the first, second and third sets (S1, S2, S3) and the second bar dipole magnets (272-a to 272-f) of the first, second and third sets (S1, S2, S3) were made of NdFeB N42; the third bar dipole magnets (273a, 273-b and 273-c) of the first and second pairs (P1, P2) were made of NdFeB N48. All the magnets (271-a to 271-c, 272-a to 272-f and 273-a to 273-d) were embedded in a non-magnetic supporting matrix (not shown) made of POM having the following dimensions: 200 mm×120 mm×12 mm.

### C) Examples E1-16 and Combinations of a) the Apparatuses (x00) Independently Comprising the Soft Magnetic Plates (x10) and the Magnetic-Field-Generating Devices (x20), and b) the Second Magnetic-Field-Generating Device (x70)

The assemblies (x00) comprising the substrate (x50) carrying the coating layer (x40), the soft magnetic plate (x10) and the magnetic-field-generating device (x20) provided in Table 3 were moved in the vicinity and below the static second magnetic-field-generating device (x70) shown in FIG. 2 as described hereabove. After having moved said assemblies (x00), the coating layers (x40) were independently cured as described hereabove.

The so-obtained optical effect layers (OELs) exhibited a dynamic movement upon tilting the substrate (x50) and one or more indicia as 3D effect. Table 3 provides the details of the dynamic movement and its area on the OEL and the details of the 3D effect and its area on the OEL.

TABLE 3

| | | magnetic- | | | | |
|---|---|---|---|---|---|---|
| | soft | field- | | | | |
| | magnetic | generating | | OEL | | |
| | plate 410 | device 520 | d-a/ | of | OEL dynamic | OEL 3D |
| Ex | in FIG. | in FIG. | mm | FIG. | movement | effect |
| E1 | 4A-1 | 5A | 8.4 | 6A | a) left | right |
| E2 | 4H | 5A | 8.4 | 6B | a) left | right |
| E3 | 4A-1 | 5B | 1.7 | 6C | b) left | right |
| E4 | 4B | 5B | 1.7 | 6D | b) center | left and |
| | | | | | | right |
| E5 | 4H | 5B | 1.7 | 6E | b) left | right |
| E6 | 4A-2 | 5B | 1.7 | 6F | b) right | left |
| E7 | 4D | 5B | 2.7 | 6G | b) right | left |
| E8 | 4M | 5A | 8.4 | 6H | a) left and right | center |
| E9 | 4M | 5B | 1.7 | 6I | b) left and right | center |
| E10 | 4D | 5C | 3.4 | 6J | c) left | right |
| E11 | 4D | 5F | 3.4 | 6K | d) left | right |
| E12 | 4A-1 | 5D | 4.4 | 6L | e) left | right |
| E13 | 4D | 5G | 3.4 | 6M | f) left | right |
| E14 | 4D | 5E | 3.4 | 6N | g) left | right |
| E15 | 4O | 5A | 8.4 | 6O | a) everywhere | left |
| E16 | 4P | 5A | 2.4 | 6P | a) everywhere | right * |

The distance d-a consist of the distance between the top surface of the magnetic-field-generating device 520 and the bottom surface of the soft magnetic plate 410.
The distance d-b (distance between the top surface of the soft magnetic plate 410 and the bottom surface of the substrate ×50) for all examples was about 0.2 mm.
* due to the presence of the engraved magnetic plate 430, the OEL further exhibited indicia in its left side.

Dynamic Movement Upon Tilting the Substrate (x50) of the OEL in Table 3

The following dynamic movements disclosed in Table 3 are the following ones:
a) bright reflective horizontal bar moving in a longitudinal direction when the substrate (x50) carrying the OEL is tilted about a longitudinal axis;
b) pattern of bright areas and dark areas moving when the substrate (x50) carrying the OELs is tilted.
c) nested multi-loop-shaped body moving when the substrate (x50) carrying the OELs is tilted;
d) moon crescent moving and rotating when the substrate (x50) carrying the OELs is tilted;
e) loop-shaped body having a size that varies when the substrate (x50) carrying the OELs is tilted;
f) loop-shaped body surrounded by one or more loop-shaped bodies, wherein said one or more loop-shaped bodies have their shape and/or brightness varying when the substrate (x50) carrying the OEL is tilted; and
g) bright reflective vertical bar moving in a longitudinal direction when the substrate (x50) carrying the OEL is tilted about a horizontal/latitudinal axis or moving in a horizontal/latitudinal direction when the substrate carrying said OEL is tilted about a longitudinal axis.

FIG. 7 shows a device in which the apparatus (700) forms the assembly (7100) while being mounted in a cylinder. The cylinder can be rotated so that it moves together with the substrate (750) on which the coating layer (740) is arranged. The cylinder comprises cavities, in which the apparatus (700) is inserted. Alternatively, the apparatus (700) may be arranged on a cylinder or may be only partially inserted.

The substrate (750) comprises the coating layer (740) and the apparatus (700) forms the assembly (7100) together with the substrate (750) and the coating layer (740).

The second magnetic-field-generating device (770) is arranged above the cylinder so that the substrate (750) and the coating layer (740) can pass between the apparatus (700) and the second magnetic-field-generating device (770).

The second magnetic-field-generating device (770) has an arc-shape in the paper plane of FIG. 7. However, the shape of the second magnetic-field-generating device (770) is not limited to such a shape. Any shape is conceivable as long as the substrate (750) can pass through a space between the second magnetic-field-generating device (770) and the apparatus (700) arranged in or on the cylinder and as long as second magnetic-field-generating device (770) and the apparatus (700) allow for bi-axially orienting the particles of the coating (740).

In this configuration the apparatus (700) is moved together with the substrate (750) and the coating (740) relative to the second magnetic field generating device (770) so that at least a part of the particles in the coating layer (740) is bi-axially oriented. After the substrate (750) has passed through the space between the cylinder and the second magnetic field generating device (770) the so obtained magnetic orientation of the particles in the coating (740) is fixed/frozen by at least partially curing with the curing unit (780).

1. A process for producing an optical effect layer (OEL) on a substrate, said optical effect layer (OEL) exhibiting a dynamic movement upon tilting the substrate and one or more indicia, said process comprising the steps of:
a) applying onto a substrate surface a coating composition comprising i) platelet-shaped magnetic or magnetizable pigment particles and ii) a binder material so as to form a coating layer on said substrate, said coating composition being in a first state,
b) forming an assembly comprising the substrate carrying the coating layer and an apparatus for producing an optical effect layer (OEL) comprising magnetically oriented platelet-shaped magnetic or magnetizable pigment particles on a substrate, said optical effect layer (OEL) comprising at least a first area exhibiting a 3D effect in the form of one or more indicia and at least a second area exhibiting a dynamic movement upon tilting, wherein at least one of said first area and at least one of said second area are adjacent, said apparatus being configured for receiving the substrate in an orientation substantially parallel to a first plane and above the first plane and being suitable to be used in combination with a second magnetic-field-generating device allowing at least a part of the particles to be to bi-axially oriented and comprising:
aa) a soft magnetic plate carrying one or more indicia in the form of one or more indentations and/or one or more voids and/or one or more protrusions, said soft magnetic plate having a top plate surface,
ab) a magnetic-field-generating device-comprising at least one dipole magnet and having a top device surface,
wherein the soft magnetic plate is placed on top of the magnetic-field-generating device, and
wherein the top plate surface is smaller than the top device surface,
c) moving the assembly comprising the substrate (x50) carrying the coating layer and the apparatus obtained under step b) through an inhomogeneous magnetic field of a static second magnetic-field-generating device so as to bi-axially orient at least a part of the platelet-shaped magnetic or magnetizable pigment particles, and
d) hardening the coating composition to a second state so as to fix the platelet-shaped magnetic or magnetizable pigment particles in their adopted positions and orientations,
wherein the optical effect layer (OEL) comprises at least a first area exhibiting a 3D effect in the form of one or more indicia and at least a second area exhibiting a dynamic movement upon tilting, wherein at least one of said first area and at least one of said second area are adjacent.

2. The process according to claim 1, wherein the first magnetic-field-generating device (x20) further comprises one or more dipole magnets arranged in the one or more indentations and/or in the one or more voids of the soft magnetic plate.

3. The process according to claim 1, wherein the dynamic movement of the optical effect layer (OEL) is a bright reflective horizontal bar moving in a longitudinal direction when substrate carrying said optical effect layer (OEL) is tilted about a longitudinal axis and wherein the at least one dipole magnet of the first magnetic-field-generating device has a magnetic axis oriented to be substantially parallel to the first plane.

4. The process according to claim 1, wherein the dynamic movement of the optical effect layer (OEL) is a pattern of bright areas and dark areas moving when the substrate carrying said optical effect layer (OEL) is tilted, and
wherein the first magnetic-field-generating device comprises the at least one dipole magnet having a magnetic axis oriented to be substantially parallel to the first plane and a combination comprising at least four additional dipole magnets having their North poles pointing in a same direction and having their magnetic axes oriented to be substantially parallel to the first plane, said first dipole magnets being spaced apart from each other,
wherein each of the additional dipole magnets is arranged on an intersection of at least two substantially parallel straight lines αᵢ (i=1, 2, . . . ) and at least two substantially parallel straight lines βⱼ (j=1, 2, . . . ), the straight lines αᵢ and βⱼ forming a grid,
wherein at least two additional dipole magnets are disposed on one of the straight lines αᵢ and at least two other additional dipole magnets are disposed on another one of the straight lines αᵢ,
wherein the magnetic axes of the additional dipole magnets are oriented substantially parallel to the substantially parallel straight lines αᵢ,
wherein the at least one dipole magnet is disposed below the combination comprising at least four first dipole magnets, and
wherein each straight line αᵢ and a vector H of the magnetic axis of the at least one dipole magnet is either i) substantially parallel or substantially perpendicular with respect to each other or ii) substantially non-parallel and substantially non-perpendicular with respect to each other.

5. The process according to claim 1, wherein the dynamic movement of the optical effect layer (OEL) is a loop-shaped body moving when the substrate carrying said optical effect layer (OEL) is tilted and wherein the first magnetic-field-generating device comprises:
a) the at least one dipole magnet having a magnetic axis oriented to be substantially perpendicular to the first plane and one or more pole pieces, said one or more pole pieces being disposed below the at least one dipole magnet and in contact with the dipole magnet and/or being spaced apart from and laterally surrounds the at least one dipole magnet;
b) the at least one dipole magnet being a loop-shaped magnet having a radial magnetization; or
c) the at least one dipole magnet being three or more dipole magnets disposed in a loop-shaped arrangement having a radial magnetization.

6. The process according to claim 1, wherein the dynamic movement of the optical effect layer (OEL) is a nested multi-loop-shaped body moving when the substrate carrying said optical effect layer (OEL) is tilted and
wherein the first magnetic-field-generating device comprises
a) the at least one dipole magnet being a loop-shaped magnet defining a loop and having a magnetic axis oriented to be substantially perpendicular to the first plane and a pole piece being disposed below the at least one dipole magnet and within the loop of said the at least one dipole magnet and having one or more protrusions disposed within the loop of the at least one dipole magnet; or
b) the at least one dipole magnet having a magnetic axis oriented to be substantially perpendicular to the first plane, an additional dipole magnet having a magnetic axis oriented to be substantially perpendicular to the first plane and two or more pole pieces, wherein said at least one dipole magnet and additional magnet have the same magnetic direction and are provided in different distances from the first plane, wherein said two or more pole pieces are arranged in the space between the magnets and in contact therewith and wherein at least one of the two or more pole pieces form one or more loop-shaped projections surrounding a central area in which the at least one dipole magnet is arranged; or
c) the at least one dipole magnet having a magnetic axis oriented to be substantially perpendicular to the first plane, a plate-like-shaped pole piece being disposed below and in contact with the at least one dipole magnet, and one or more loop-shaped pole pieces being disposed on top the at least one dipole magnet, wherein a central pole piece of said one or more loop-shaped pole pieces is in contact with the at least one dipole magnet.

7. The process according to claim 1, wherein the dynamic movement of the optical effect layer (OEL) is a moon crescent moving and rotating when the substrate carrying said optical effect layer (OEL) is tilted and wherein the first magnetic-field-generating device comprises a) the at least one dipole magnet being a first dipole magnet having its North-South magnetic axis substantially perpendicular to the substrate surface and having length L1, b) a second dipole magnet having its North-South magnetic axis substantially perpendicular to the first plane and having a length L3, and c) a flat pole piece lacking any protrusions or projections extending outside the surface of said pole piece and having a length L5, wherein the first dipole magnet and the second dipole magnet have a same magnetic field direction, wherein the first dipole magnet faces the substrate and is disposed on top of the flat pole piece, wherein the second dipole magnet faces the environment and is disposed below the flat pole piece, wherein the length L1 of the first dipole magnet is smaller than the length L3 of the second dipole magnet, wherein the length L1 of the first dipole magnet is smaller than the length L5 of the flat pole piece, and wherein the length L3 of the second dipole magnet is smaller than the length L5 of the pole piece.

8. The process according to claim 1, and wherein the dynamic movement of the optical effect layer (OEL) is a loop-shaped body having a size that varies when the substrate carrying said optical effect layer (OEL) is tilted and
wherein the first magnetic-field-generating device comprises:
a) the at least one dipole magnet being either a single bar dipole magnet having a North-South magnetic axis substantially parallel to first plane or a combination of two or more bar dipole magnets having a resulting North-South magnetic axis substantially parallel to the first plane and b) a loop-shaped magnetic-field generating device being either a single loop-shaped dipole magnet having a North-South magnetic axis substantially perpendicular to the first plane or a combination of two or more dipole magnets disposed in a loop-shaped arrangement and having a resulting North-South magnetic axis substantially perpendicular to the first plane, or
a) the at least one dipole magnet being either a single dipole magnet having a magnetic axis substantially parallel to the first plane or a combination of two or more bar dipole magnets, each of the two or more bar dipole magnets having a magnetic axis substantially parallel to the first plane and having a same magnetic field direction, b) a loop-shaped magnetic-field generating device being either a single loop-shaped dipole magnet having a magnetic axis substantially perpendicular to the first plane or a combination of two or more dipole magnets disposed in a loop-shaped arrangement, each of the two or more dipole magnets having a magnetic axis substantially perpendicular to the first plane and having a same magnetic field direction, and c) a single dipole magnet having a magnetic axis substantially perpendicular to the first plane or two or more dipole magnets, each of the two or more dipole magnets having a magnetic axis substantially perpendicular to the first plane and having a same magnetic field direction and/or one or more pole pieces, or
a) the at least one dipole magnet being either a single bar dipole magnet having a magnetic axis substantially parallel to the first plane or a combination of two or more bar dipole magnets, each of the two or more bar dipole magnets having a magnetic axis substantially parallel to the first plane and having a same magnetic field direction, b) a loop-shaped magnetic-field generating device being either a single loop-shaped magnet or a combination of two or more dipole magnets, disposed in a loop-shaped arrangement, the loop-shaped magnetic-field generating device having a radial magnetization, and c) a single dipole magnet having a magnetic axis substantially perpendicular to the first plane or a single dipole magnet having a magnetic axis substantially parallel to the first plane, or two or more dipole magnets, each of said two or more dipole magnets having a magnetic axis substantially perpendicular to the first plane, wherein the North pole of said single dipole magnet or the North pole of said at least one of said two or more dipole magnets is pointing towards the substrate surface when the North pole of the single loop-shaped magnet or of the two or more dipole magnets forming the loop-shaped magnetic-field generating device is pointing towards the periphery of said loop-shaped magnetic-field generating device, or wherein the South pole of said single dipole magnet or the South pole of at least one of said two or more dipole magnets is pointing towards the first plane when the South pole of the single loop-shaped magnet or of the two or more dipole magnets forming the loop-shaped magnetic-field generating device is pointing towards the periphery of said loop-shaped magnetic-field generating device.

9. The process according to claim 1, wherein the dynamic movement of the optical effect layer (OEL) is a loop-shaped body surrounded by one or more loop-shaped bodies, wherein said one or more loop-shaped bodies have their shape and/or their brightness varying when the substrate carrying said optical effect layer (OEL) is tilted and
wherein the first magnetic-field-generating device comprises
a) a combination of three or more first dipole magnets x20-bi (x20b1, x20-b2, x20-b3, . . . ), each of said first dipole magnets having its center C_{x20-bi} (C_{x20-b1}, C_{x20-b2}, C_{x20-b3}, . . . ) disposed on a loop in the first plane, wherein said first dipole magnets x20-bi (x20-b1, x20-b2, x20-b3, . . . ) have their magnetic axes oriented to be substantially parallel to the first plane (P) and
b) the at least one dipole magnet having its magnetic axis oriented to be substantially perpendicular to the first plane and being arranged to have a projection of its center on the first plane be located at a projection point Cₓ₂₀₋ₐ within the loop, wherein the at least one dipole magnet is disposed above the combination of three or more first dipole magnets,
wherein angles αᵢ are formed between each of the vectors (\vec{Cₓ₂₀₋ₐC_{x20-bi}} (\vec{Cₓ₂₀₋ₐC_{x20-b1}}, \vec{Cₓ₂₀₋ₐC_{x20-b2}}, Cₓ₂₀₋ₐC_{x20-b3} . . . ) and the vector \vec{h_{x20-bi}} (\vec{h_{x20-b1}}, \vec{h_{x20-b2}}, \vec{h_{x20-b3}}, . . . ) of the magnetic axis of the respective first dipole magnet x20-bi (x20-b1, x20-b2, x20-b3, . . . ),
wherein all of the angles αᵢ, when measured in a counterclockwise direction, are in the range from about 20° to about 160° or in the range from about 200° to about 340°, and wherein each of the first dipole magnets x20-bi (x20-b1, x20-b2, x20-b3, . . . ) is disposed at a first distance, said first distance being on the first plane between the projection point Cₓ₂₀₋ₐ and the center C_{x20-bi} (C_{x20-b1}, C_{x20-b2}, C_{x20-b3}, . . . ) of the first dipole magnet x20-bi (x20-b1, x20-b2, x20-b3, . . . ).

10. The process according to claim 1, wherein the dynamic movement of the optical effect layer (OEL) is a bright reflective vertical bar moving in a longitudinal direction when the substrate carrying said optical effect layer (OEL) is tilted about a horizontal/latitudinal axis or moving in a horizontal/latitudinal direction when the substrate carrying said optical effect layer (OEL) is tilted about a longitudinal axis and
wherein the first magnetic-field-generating device comprises:
a) the at least one dipole magnet being a square-shaped or rectangle-shaped dipole magnet having its magnetic axis oriented to be substantially parallel to the first plane, and
b) a combination of n sets of spaced apart bar dipole magnets with n being an integer equal to or bigger than 1, wherein each of said bar dipole magnets has its North-South magnetic axis substantially parallel to the substrate surface, wherein, for each set of said n sets, the bar dipole magnets have their North pole pointing in a same direction and are substantially parallel to each other,
wherein the vector sum H1 of the magnetic axes of the bar dipole magnets and the vector sum H2 of the at least one dipole magnet form an angle α in the range from about 5° to about 175° or in the range from about 185° to about 355°,
wherein the combination of n sets of spaced apart bar dipole magnets is placed below or on top of the second least one dipole magnet, and
wherein the at least one dipole magnet and combination of n sets of spaced apart bar dipole magnets are essentially centered with respect to one another.

11. The process according to claim 1, wherein the soft magnetic plate is soft magnetic composite plate comprising from about 50 wt-% to about 90 wt-%, of soft magnetic particles, the weight percents being based on the total weight of the one or more soft magnetic composite plate and wherein the one or more indentations have a depth between about 5% and about 99% and/or the one or more protrusions have a height between about 5% and about 10000%.

12. The process according to claim 1, further comprising an engraved magnetic plate comprising one or more engravings in the form of indicia, wherein said engraved magnetic plate is placed on top of the first magnetic-field-generating device and has a top plate engraved magnetic surface being flush with the top plate surface of the soft magnetic plate, wherein said engraved magnetic plate is made of Plastoferrite.

13. (canceled)

14. The process according to claim 1, wherein the apparatus faces the substrate, wherein the substrate of the assembly carrying the coating layer is arranged above the soft magnetic plate, the soft magnetic plate faces the substrate and the coating layer is a topmost layer of the assembly.

15. A device for producing an optical effect layer (OEL) comprising magnetically oriented platelet-shaped magnetic or magnetizable pigment particles on a substrate, said optical effect layer (OEL) comprising at least a first area exhibiting a 3D effect in the form of one or more indicia and at least a second area exhibiting a dynamic movement upon tilting, wherein at least one of said first area and at least one of said second area are adjacent, said device (x00) being configured for receiving the substrate and comprises a
a first magnetic-field-generating device comprising at least one dipole magnet and having a top device surface,
a second magnetic-field-generating device,
a soft magnetic plate carrying the one or more indicia in the form of one or more indentations and/or one or more voids and/or one or more protrusions, said soft magnetic plate having a top plate surface,
wherein the soft magnetic plate is placed on top of the first magnetic-field-generating device, and
wherein the top plate surface is smaller than the top device surface,
wherein the first magnetic-field-generating device and the soft magnetic plate are arranged on or in cylinder so that, when the cylinder is rotated, the first magnetic-field-generating device and second magnetic-field-generating device are moved relative to each other so that the top device surface of the first magnetic-field-generating-device faces the second magnetic-field-generating device allowing at least a part of the particles to be bi-axially oriented.

16. The device according to claim 15, wherein the first magnetic-field-generating device further comprises one or more dipole magnets arranged in the one or more indentations and/or in the one or more voids of the soft magnetic plate and/or wherein the second magnetic-field-generating device is arc-shaped in a section orthogonal to the height of the cylinder and/or wherein the position of the cylinder's axis of rotation is fixed relative to the second magnetic-field-generating device.

17. The device according to claim 15, wherein the dynamic movement of the optical effect layer (OEL) is a bright reflective horizontal bar moving in a longitudinal direction when substrate carrying said optical effect layer (OEL) is tilted about a longitudinal axis and wherein the at least one dipole magnet of the first magnetic-field-generating device has a magnetic axis oriented to be substantially parallel to the first plane.

18. The device according to claim 15, wherein the dynamic movement of the optical effect layer (OEL) is a pattern of bright areas and dark areas moving when the substrate carrying said optical effect layer (OEL) is tilted, and
wherein the first magnetic-field-generating device comprises the at least one dipole magnet having a magnetic axis oriented to be substantially parallel to the first plane (P) and a combination comprising at least four additional dipole magnets having their North poles pointing in a same direction and having their magnetic axes oriented to be substantially parallel to the first plane, said first dipole magnets being spaced apart from each other,
wherein each of the additional dipole magnets is arranged on an intersection of at least two substantially parallel straight lines αᵢ (i=1, 2, . . . ) and at least two substantially parallel straight lines βⱼ (j=1, 2, . . . ), the straight lines αᵢ and βⱼ
forming a grid,
wherein at least two additional dipole magnets are disposed on one of the straight lines α₁ and at least two other additional dipole magnets are disposed on another one of the straight lines αᵢ,
wherein the magnetic axes of the additional dipole magnets are oriented substantially parallel to the substantially parallel straight lines αᵢ,
wherein the at least one dipole magnet is disposed below the combination comprising at least four first dipole magnets, and
wherein each straight line αᵢ and a vector H of the magnetic axis of the at least one dipole magnet is either i) substantially parallel or substantially perpendicular with respect to each other or ii) substantially non-parallel and substantially non-perpendicular with respect to each other.

19. The device according to claim 15, wherein the dynamic movement of the optical effect layer (OEL) is a loop-shaped body moving when the substrate carrying said optical effect layer (OEL) is tilted and wherein the first magnetic-field-generating device comprises:
a) the at least one dipole magnet having a magnetic axis oriented to be substantially perpendicular to the first plane and one or more pole pieces, said one or more pole pieces being disposed below the at least one dipole magnet and in contact with the dipole magnet and/or being spaced apart from and laterally surrounds the at least one dipole magnet;
b) the at least one dipole magnet being a loop-shaped magnet having a radial magnetization; or
c) the at least one dipole magnet being three or more dipole magnets disposed in a loop-shaped arrangement having a radial magnetization.

20. The device according to claim 15, wherein the dynamic movement of the optical effect layer (OEL) is a nested multi-loop-shaped body moving when the substrate carrying said optical effect layer (OEL) is tilted and
wherein the first magnetic-field-generating device comprises
a) the at least one dipole magnet being a loop-shaped magnet defining a loop and having a magnetic axis oriented to be substantially perpendicular to the first plane and a pole piece being disposed below the at least one dipole magnet and within the loop of said the at least one dipole magnet and having one or more protrusions disposed within the loop of the at least one dipole magnet; or
b) the at least one dipole magnet having a magnetic axis oriented to be substantially perpendicular to the first plane, an additional dipole magnet having a magnetic axis oriented to be substantially perpendicular to the first plane and two or more pole pieces, wherein said at least one dipole magnet and additional magnet have the same magnetic direction and are provided in different distances from the first plane, wherein said two or more pole pieces are arranged in the space between the magnets and in contact therewith and wherein at least one of the two or more pole pieces form one or more loop-shaped projections surrounding a central area in which the at least one dipole magnet is arranged; or
c) the at least one dipole magnet having a magnetic axis oriented to be substantially perpendicular to the first plane, a plate-like-shaped pole piece being disposed below and in contact with the at least one dipole magnet, and one or more loop-shaped pole pieces being disposed on top the at least one dipole magnet, wherein a central pole piece of said one or more loop-shaped pole pieces is in contact with the at least one dipole magnet.

21. The device according to claim 15, wherein the dynamic movement of the optical effect layer (OEL) is a moon crescent moving and rotating when the substrate carrying said optical effect layer (OEL) is tilted and wherein the first magnetic-field-generating device comprises a) the at least one dipole magnet being a first dipole magnet having its North-South magnetic axis substantially perpendicular to the substrate surface and having length L1, b) a second dipole magnet having its North-South magnetic axis substantially perpendicular to the first plane and having a length L3, and c) a flat pole piece lacking any protrusions or projections extending outside the surface of said pole piece and having a length L5, wherein the first dipole magnet and the second dipole magnet have a same magnetic field direction, wherein the first dipole magnet faces the substrate and is disposed on top of the flat pole piece, wherein the second dipole magnet faces the environment and is disposed below the flat pole piece, wherein the length L1 of the first dipole magnet is smaller than the length L3 of the second dipole magnet, wherein the length L1 of the first dipole magnet is smaller than the length L5 of the flat pole piece, and wherein the length L3 of the second dipole magnet is smaller than the length L5 of the pole piece.

22. The device according to claim 15, and wherein the dynamic movement of the optical effect layer (OEL) is a loop-shaped body having a size that varies when the substrate carrying said optical effect layer (OEL) is tilted and
wherein the first magnetic-field-generating device comprises:
a) the at least one dipole magnet being either a single bar dipole magnet having a North-South magnetic axis substantially parallel to first plane or a combination of two or more bar dipole magnets having a resulting North-South magnetic axis substantially parallel to the first plane and b) a loop-shaped magnetic-field generating device being either a single loop-shaped dipole magnet having a North-South magnetic axis substantially perpendicular to the first plane or a combination of two or more dipole magnets disposed in a loop-shaped arrangement and having a resulting North-South magnetic axis substantially perpendicular to the first plane, or
a) the at least one dipole magnet being either a single dipole magnet having a magnetic axis substantially parallel to the first plane or a combination of two or more bar dipole magnets, each of the two or more bar dipole magnets having a magnetic axis substantially parallel to the first plane and having a same magnetic field direction, b) a loop-shaped magnetic-field generating device being either a single loop-shaped dipole magnet having a magnetic axis substantially perpendicular to the first plane or a combination of two or more dipole magnets disposed in a loop-shaped arrangement, each of the two or more dipole magnets having a magnetic axis substantially perpendicular to the first plane and having a same magnetic field direction, and c) a single dipole magnet having a magnetic axis substantially perpendicular to the first plane or two or more dipole magnets, each of the two or more dipole magnets having a magnetic axis substantially perpendicular to the first plane and having a same magnetic field direction and/or one or more pole pieces, or
a) the at least one dipole magnet being either a single bar dipole magnet having a magnetic axis substantially parallel to the first plane or a combination of two or more bar dipole magnets, each of the two or more bar dipole magnets having a magnetic axis substantially parallel to the first plane and having a same magnetic field direction, b) a loop-shaped magnetic-field generating device being either a single loop-shaped magnet or a combination of two or more dipole magnets, disposed in a loop-shaped arrangement, the loop-shaped magnetic-field generating device having a radial magnetization, and c) a single dipole magnet having a magnetic axis substantially perpendicular to the first plane or a single dipole magnet having a magnetic axis substantially parallel to the first plane, or two or more dipole magnets, each of said two or more dipole magnets having a magnetic axis substantially perpendicular to the first plane, wherein the North pole of said single dipole magnet or the North pole of said at least one of said two or more dipole magnets is pointing towards the substrate surface when the North pole of the single loop-shaped magnet or of the two or more dipole magnets forming the loop-shaped magnetic-field generating device is pointing towards the periphery of said loop-shaped magnetic-field generating device, or wherein the South pole of said single dipole magnet or the South pole of at least one of said two or more dipole magnets is pointing towards the first plane when the South pole of the single loop-shaped magnet or of the two or more dipole magnets forming the loop-shaped magnetic-field generating device is pointing towards the periphery of said loop-shaped magnetic-field generating device.

23. The device according to claim 15, wherein the dynamic movement of the optical effect layer (OEL) is a loop-shaped body surrounded by one or more loop-shaped bodies, wherein said one or more loop-shaped bodies have their shape and/or their brightness varying when the substrate carrying said optical effect layer (OEL) is tilted and
wherein the first magnetic-field-generating device comprises
a) a combination of three or more first dipole magnets x20-bi (x20-b1, x20-b2, x20-b3, . . . ), each of said first dipole magnets having its center C_{x20-bi} (C_{x20-b1}, C_{x20-b2}, C_{x20-b3}, . . . ) disposed on a loop in the first plane, wherein said first dipole magnets x20-bi (x20-b1, x20-b2, x20-b3, . . . ) have their magnetic axes oriented to be substantially parallel to the first plane and
b) the at least one dipole magnet having its magnetic axis oriented to be substantially perpendicular to the first plane and being arranged to have a projection of its center on the first plane be located at a projection point Cₓ₂₀₋ₐ within the loop, wherein the at least one dipole magnet is disposed above the combination of three or more first dipole magnets,
wherein angles αᵢ are formed between each of the vectors (\vec{Cₓ₂₀₋ₐC_{x20-bi}} \vec{Cₓ₂₀₋ₐC_{x20-b1},} \vec{Cₓ₂₀₋ₐC_{x20-b2}}, Cₓ₂₀₋ₐC_{x20-b3} . . . ) and the vector \vec{h_{x20-bi}} (\vec{h_{x20-b1}}, \vec{h_{x20-b2}}, \vec{h_{x20-b3}}, . . . ) of the magnetic axis of the respective first dipole magnet x20-bi (x20-b1, x20-b2, x20-b3, . . . ),
wherein all of the angles ai, when measured in a counterclockwise direction, are in the range from about 20° to about 160° or in the range from about 200° to about 340°, and
wherein each of the first dipole magnets x20-bi (x20-b1, x20-b2, x20-b3, . . . ) is disposed at a first distance, said first distance being on the first plane (P) between the projection point Cₓ₂₀₋ₐ and the center C_{x20-bi} (C_{x20-b1}, C_{x20-b2}, C_{x20-b3}, . . . ) of the first dipole magnet x20-bi (x20-b1, x20-b2, x20-b3, . . . ).

24. The device according to claim 15, wherein the dynamic movement of the optical effect layer (OEL) is a bright reflective vertical bar moving in a longitudinal direction when the substrate carrying said optical effect layer (OEL) is tilted about a horizontal/latitudinal axis or moving in a horizontal/latitudinal direction when the substrate carrying said optical effect layer (OEL) is tilted about a longitudinal axis and
wherein the first magnetic-field-generating device comprises:
a) the at least one dipole magnet being a square-shaped or rectangle-shaped dipole magnet having its magnetic axis oriented to be substantially parallel to the first plane, and
b) a combination of n sets of spaced apart bar dipole magnets with n being an integer equal to or bigger than 1, wherein each of said bar dipole magnets has its North-South magnetic axis substantially parallel to the substrate surface, wherein, for each set of said n sets, the bar dipole magnets have their North pole pointing in a same direction and are substantially parallel to each other,
wherein the vector sum H1 of the magnetic axes of the bar dipole magnets and the vector sum H2 of the at least one dipole magnet form an angle α in the range from about 5° to about 175° or in the range from about 185° to about 355°,
wherein the combination of n sets of spaced apart bar dipole magnets is placed below or on top of the second least one dipole magnet, and
wherein the at least one dipole magnet and combination of n sets of spaced apart bar dipole magnets are essentially centered with respect to one another.

25. The device according to claim 15, wherein the soft magnetic plate is soft magnetic composite plate comprising from about 50 wt-% to about 90 wt-%, of soft magnetic particles, the weight percents being based on the total weight of the one or more soft magnetic composite plate and wherein the one or more indentations have a depth between about 5% and about 99% and/or the one or more protrusions have a height between about 5% and about 10000%.

26. The device according to claim 15, further comprising an engraved magnetic plate comprising one or more engravings in the form of indicia, wherein said engraved magnetic plate is placed on top of the first magnetic-field-generating device and has a top plate engraved magnetic surface being flush with the top plate surface of the soft magnetic plate, wherein said engraved magnetic plate is made of Plastoferrite.

27. (canceled)
